(19) United States
(12) Patent Application Publication
(10) Pub. No.: US 2024/0062041 A1
(43) Pub. Date: Feb. 22, 2024

(54) GRAPH NEURAL NETWORK BASED METHODS AND SYSTEMS FOR FRAUD DETECTION IN ELECTRONIC TRANSACTIONS

(71) Applicant: MASTERCARD INTERNATIONAL INCORPORATED, Purchase, NY (US)

(72) Inventors: Akash Choudhary, Delhi (IN); Janu Verma, Nowshera (IN); Garima Arora, Delhi (IN); Adarsh Patankar, Betul (IN)

(73) Assignee: MASTERCARD INTERNATIONAL INCORPORATED, Purchase, NY (US)

(21) Appl. No.: 18/448,727

(22) Filed: Aug. 11, 2023

(30) Foreign Application Priority Data
Aug. 12, 2022 (IN) 202241046200

(51) Int. Cl. G06N 3/045; G06N 3/0895; G06Q 20/40

(52) U.S. Cl. CPC G06N 3/045; G06N 3/0895; G06Q 20/4016

(57) ABSTRACT

Methods and server systems for detecting fraudulent transactions are described herein. Method performed by server system includes accessing base graph including plurality of nodes further including plurality of labeled nodes and unlabeled nodes. Method includes assigning via Graph Neural Network (GNN) model, fraudulent label or non-fraudulent label to each unlabeled node based on the base graph. This assigning process includes generating plurality of sub-graphs based on splitting the base graph and filtering these sub-graphs via Siamese Neural Network model based on pre-defined threshold values. Then, the GNN model generates plurality of sets of embeddings based on plurality of filtered sub-graphs. Further, aggregated node embedding is generated for each node and then, final node representation for each node is generated via dense layer of GNN model. Then, fraudulent label or the non-fraudulent label is assigned to each unlabeled node of plurality of unlabeled nodes based on final node representation.

### TECHNICAL FIELD

The present disclosure relates to artificial intelligence processing systems and, more particularly to, graph neural network (GNN) based electronic methods and complex processing systems for detecting fraudulent transactions in electronic payment transactions.

### BACKGROUND

Fraud has become prevalent in nearly all businesses ranging from finance, security, healthcare, online reviews, and so on. Additionally, a plethora of machine learning-based fraud detection models has been proposed in the past based on supervised and unsupervised learning. However, supervised methods rely on learning from labeled data having sufficient verified examples of fraud incidents. The fraud classification task in a supervised learning setting is a challenging modeling problem because, unlike other classification tasks, the class ratio within this data is highly imbalanced. Hence, unsupervised learning methods are also used which greatly focus on finding anomalous trends and user behavior patterns based on factors such as historical transactions, anomalous patterns, and exceptional events.

In recent times, graph-based artificial intelligence models (e.g., graph neural networks (GNNs)) have attracted attention since they exploit the behavioral interactions among both fraudulent and non-fraudulent entities. For example, on an e-commerce platform, a fraudster can use the information of other fraudsters for making purchases, or a spammer may post fake reviews for multiple products along with genuine reviews.

Over the last few years, graph-based neural network (NN) models have garnered a lot of attention in fraud detection tasks due to the relational nature of fraud behavior. The graph-based NN models have been used in various graph analytical problems including, for example, link prediction, node classification, graph classification, and so on. Most of the graph-based NN models rely on aggregating information from neighbors to make inferences for a given node. However, such NN models do not explicitly identify which neighbor nodes are valuable to the learning task and which may be harmful to the model's performance. Additionally, in various real-world fraud situations, the label distribution is highly skewed due to a small fraction of fraudulent electronic transactions as compared to non-fraudulent electronic transactions. This problem of sampling relevant neighbors to include in GNN aggregation is further exacerbated in scenarios with heavy class-imbalance since a fraudulent node can easily camouflage among a lot of non-fraud nodes and rely on the neighbor aggregation to evade the fraud detector.

In an example, in a real-world review dataset R, 14.5% of the reviews are spam, and the remaining reviews are regarded as real or recommended reviews. In another example, in a real-world financial dataset F, only 0.5% of the users are defaulters who are unable to repay the credit debts borrowed from the financial platforms. Therefore, the supervised machine learning models for fraud detection need to be adept at dealing with the class-imbalance problem. This is particularly important for GNN-based models which aggregate the neighborhood information to build a representation of a node. For example, fraudsters can hide by connecting to many benign entities (i.e., those posting regular reviews or connecting to financially reputable users, etc.). As such, the GNN aggregation tends to miss such behavior since it assigns equal importance to all neighbors.

Thus, it is of paramount importance to be able to assign an appropriate measure of importance or weight to each of the neighbors at the time of information aggregation. In conventional feature-based supervised learning settings, past research works have mainly focused on solving the class imbalance problem by using varied re-sampling and re-weighting techniques. Re-sampling includes methods like oversampling the minority class examples and under-sampling the majority class examples. These methods are useful when there are a large number of examples present in overall training data but limited examples for the target minority class. Re-weighting methods balance the dataset by assigning each class hard-weights or weighting samples of data before training a model.

While the problem of class imbalance in traditional supervised machine learning models, where structured feature space is present, is relatively well explored, there is a dearth of GNN-based approaches designed for handling label-imbalanced scenarios. In an exemplary conventional approach, two kinds of regularizers are proposed—class conditioned adversarial regularizer and latent distribution alignment regularizer. This, however, works well for small graphs but doesn't scale well to large real-world graphs. In another exemplary conventional approach, a label-balanced sampler facilitates sampling nodes and links from the graph to generate sub-graphs for mini-batch training. For every node within the sub-graph, candidate neighbors are chosen by means of a scoring function based on a learnable parameterized distance function. Then, the information from the sampled neighbors and different relations are aggregated to obtain the final representation of a target node.

Thus, there is a technological need for a technical solution for improving existing fraud detection models with a higher degree of accuracy.

### SUMMARY

Various embodiments of the present disclosure provide methods and systems for detecting fraudulent transactions and assigning one of a fraudulent label or a non-fraudulent label to an unlabeled node from a plurality of nodes associated with a plurality of entities involved in payment transactions.

In an embodiment, a computer-implemented method for assigning one of a fraudulent label or a non-fraudulent label to an unlabeled node from a plurality of nodes associated with a plurality of entities involved in payment transactions is disclosed. The computer-implemented method performed by a server system includes accessing a base graph associated with a plurality of entities from a transaction database. The base graph includes a plurality of nodes connected via a plurality of edges. Further, the plurality of nodes includes a plurality of labeled nodes and a plurality of unlabeled nodes. Herein, each node of the plurality of labeled nodes is labeled with one of a fraudulent label and a non-fraudulent label. The method includes assigning via a Graph Neural Network (GNN) model, one of the fraudulent label and the non-fraudulent label to each unlabeled node of the plurality of unlabeled nodes based, at least in part, on the base graph. This assigning process includes performing a first set of operations.

The first set of operations includes generating a plurality of sub-graphs based, at least in part, on splitting the base graph. Herein, each sub-graph of the plurality of sub-graphs includes a subset of nodes from the plurality of nodes. Further, herein each subset of nodes corresponds to a particular label. Then, the first set of operations includes generating via a Siamese Neural Network (SNN) model, a plurality of filtered sub-graphs based, at least in part, on the plurality of sub-graphs and a set of pre-defined threshold values. Then, the first set of operations includes generating via the GNN model, a plurality of sets of embeddings based, at least in part, on the plurality of filtered sub-graphs. Herein, each set of embeddings of the plurality of sets of embeddings generated corresponds to each filtered sub-graph of the plurality of filtered sub-graphs. Then, the first set of operations includes generating an aggregated node embedding for each node of the plurality of nodes based, at least in part, on aggregating the plurality of sets of embeddings using an aggregation function. Then, the first set of operations includes generating via a dense layer of the GNN model, a final node representation for each node of the plurality of nodes based, at least in part, on the aggregated node embedding for each node of the plurality of nodes. Thereafter, the first set of operations includes assigning one of the fraudulent label and the non-fraudulent label to each unlabeled node of the plurality of unlabeled nodes based, at least in part, on the final node representation for the corresponding unlabeled node.

In another embodiment, a server system is disclosed. The server system includes a communication interface and a memory including executable instructions. The server system also includes a processor communicably coupled to the memory. The processor is configured to execute the instructions to cause the server system, at least in part, to access a base graph associated with a plurality of entities from a transaction database. The base graph includes a plurality of nodes connected via a plurality of edges. Further, the plurality of nodes includes a plurality of labeled nodes and a plurality of unlabeled nodes. Herein, each node of the plurality of labeled nodes is labeled with one of a fraudulent label and a non-fraudulent label. Further, the server system is caused to assign via a Graph Neural Network (GNN) model, one of the fraudulent label and the non-fraudulent label to each unlabeled node of the plurality of unlabeled nodes based, at least in part, on the base graph. This assigning process includes performing a first set of operations.

The first set of operations includes generating a plurality of sub-graphs based, at least in part, on splitting the base graph. Herein, each sub-graph of the plurality of sub-graphs includes a subset of nodes from the plurality of nodes. Further, herein each subset of nodes corresponds to a particular label. Then, the first set of operations includes generating via a Siamese Neural Network (SNN) model, a plurality of filtered sub-graphs based, at least in part, on the plurality of sub-graphs and a set of pre-defined threshold values. Then, the first set of operations includes generating via the GNN model, a plurality of sets of embeddings based, at least in part, on the plurality of filtered sub-graphs. Herein, each set of embeddings of the plurality of sets of embeddings generated corresponds to each filtered sub-graph of the plurality of filtered sub-graphs. Then, the first set of operations includes generating an aggregated node embedding for each node of the plurality of nodes based, at least in part, on aggregating the plurality of sets of embeddings using an aggregation function. Then, the first set of operations includes generating via a dense layer of the GNN model, a final node representation for each node of the plurality of nodes based, at least in part, on the aggregated node embedding for each node of the plurality of nodes. Thereafter, the first set of operations includes assigning one of the fraudulent label and the non-fraudulent label to each unlabeled node of the plurality of unlabeled nodes based, at least in part, on the final node representation for the corresponding unlabeled node.

In yet another embodiment, a non-transitory computer-readable storage medium is disclosed. The non-transitory computer-readable storage medium includes computer-executable instructions that, when executed by at least a processor of a server system, cause the server system to perform a method. The method includes accessing a base graph associated with a plurality of entities from a transaction database. The base graph includes a plurality of nodes connected via a plurality of edges. Further, the plurality of nodes includes a plurality of labeled nodes and a plurality of unlabeled nodes. Herein, each node of the plurality of labeled nodes is labeled with one of a fraudulent label and a non-fraudulent label. The method includes assigning via a Graph Neural Network (GNN) model, one of the fraudulent label and the non-fraudulent label to each unlabeled node of the plurality of unlabeled nodes based, at least in part, on the base graph. This assigning process includes performing a first set of operations.

The first set of operations includes generating a plurality of sub-graphs based, at least in part, on splitting the base graph. Herein, each sub-graph of the plurality of sub-graphs includes a subset of nodes from the plurality of nodes. Further, herein each subset of nodes corresponds to a particular label. Then, the first set of operations includes generating via a Siamese Neural Network (SNN) model, a plurality of filtered sub-graphs based, at least in part, on the plurality of sub-graphs and a set of pre-defined threshold values. Then, the first set of operations includes generating via the GNN model, a plurality of sets of embeddings based, at least in part, on the plurality of filtered sub-graphs. Herein, each set of embeddings of the plurality of sets of embeddings generated corresponds to each filtered sub-graph of the plurality of filtered sub-graphs. Then, the first set of operations includes generating an aggregated node embedding for each node of the plurality of nodes based, at least in part, on aggregating the plurality of sets of embeddings using an aggregation function. Then, the first set of operations includes generating via a dense layer of the GNN model, a final node representation for each node of the plurality of nodes based, at least in part, on the aggregated node embedding for each node of the plurality of nodes. Thereafter, the first set of operations includes assigning one of the fraudulent label and the non-fraudulent label to each unlabeled node of the plurality of unlabeled nodes based, at least in part, on the final node representation for the corresponding unlabeled node.

### BRIEF DESCRIPTION OF THE FIGURES

For a more complete understanding of embodiments of the present technology, reference is now made to the following descriptions taken in connection with the accompanying drawings in which:

FIG. 1 illustrates an example representation of an environment related to at least some embodiments of the present disclosure;

FIG. 2 is a simplified block diagram of a server system, in accordance with an embodiment of the present disclosure;

FIG. 3 is a block diagram representation of the training of a Siamese Neural Network (SNN) model, in accordance with an embodiment of the present disclosure;

FIG. 4 is an exemplary block diagram representation of the generation of a plurality of sub-graphs from a base graph, in accordance with an embodiment of the present disclosure;

FIG. 5 is a schematic representation of the implementation of the graph neural network (GNN) model to label unlabeled nodes in a base graph, in accordance with an embodiment of the present disclosure;

FIG. 6 is a flow chart of training of Siamese neural network (SNN) model, in accordance with an embodiment of the present disclosure;

FIG. 7 is a flow chart of the implementation of the graph neural network (GNN) model, in accordance with an embodiment of the present disclosure;

FIG. 8 illustrates a process flow diagram depicting a method for detecting fraudulent transactions in electronic payment transactions, in accordance with an embodiment of the present disclosure; and

FIG. 9 is a simplified block diagram of a payment server, in accordance with an embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification is not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The term “payment network”, used herein, refers to a network or collection of systems used for the transfer of funds through the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash substitutes that may include payment cards, letters of credit, checks, financial accounts, etc. Examples of networks or systems configured to perform as payment networks include those operated by such as, Mastercard®.

The term “merchant”, used throughout the description generally refers to a seller, a retailer, a purchase location, an organization, or any other entity that is in the business of selling goods or providing services, and it can refer to either a single business location or a chain of business locations of the same entity.

The terms “cardholder”, “user”, and “account holder” are used interchangeably throughout the description and refer to a person who holds a payment card such as a credit or a debit card that will be used by the cardholder at a merchant to perform a payment transaction.

The terms “payment transaction”, “financial transaction”, and “electronic transaction” are used interchangeably throughout the description and may refer to electronic financial transactions including, for example, an online payment, a payment at a terminal (e.g., point of sale (POS) terminal), a transaction at an automated teller machine (ATM), and the like. Generally, a payment transaction is performed between two entities, such as a buyer and a seller. It is to be noted that a payment transaction is followed by a payment transfer of a transaction amount (i.e., monetary value) from one entity (e.g., issuing bank associated with the buyer) to another entity (e.g., acquiring bank associated with the seller), in exchange of any goods or services.

### Overview

Graph-based techniques have achieved impressive results in various tasks in different domains. Additionally, such techniques provide a way to capture the topological relationships of an entity with other entities within a network, which proves to be helpful in detecting and understanding the associations among different entities within a graph. To that end, these techniques are able to differentiate between genuine and suspicious activity patterns within the graph.

Conventional graph analysis techniques used for fraud detection involve extracting graph-based features from a graph, measuring the similarity/proximity of nodes within the graph, and finding densely connected communities or clusters within the graph. In an example, conventional graph analysis techniques can explore how interactions between nodes in a heterogeneous network of reviews take place and determine which of these reviews are spam. Further, they can describe an iterative training system to flag suspicious reviewers. Such conventional graph analysis techniques typically used feature creation techniques to capture the structural information from the graphical relationships. However, this structural information is difficult to capture and generalize in the case of non-relational datasets. Nonetheless, graph neural network (GNN) based models have been known to showcase promising results in tasks such as fraud detection, including, for example, opinion fraud detection, financial fraud detection, mobile fraud detection, cyber-crime detection, and the like.

In a conventional GNN-based implementation, a graph convolutional network (GCN) is utilized to perform fraudster detection in an online application review system. In another conventional GNN-based implementation, a semi-supervised attentive graph neural network (GNN) utilizes multi-view labeled and unlabeled data for fraud detection. In yet another conventional GNN-based implementation, a GCN-based model proposes a large-scale anti-spam method for detecting spam advertisements.

These conventional approaches extend GNN-based models to reveal the suspiciousness of nodes by aggregating node information via different relations, enhancing feature representations of objects/users. However, some of the conventional GNN-based models have explored the camouflage behaviors of fraudsters, which further impacts the performance of GNN-based models. For example, in one of the conventional GNN-based models, it is claimed that the aggregation in GNN assumes that neighbors share similar contexts, features, and relations. However, the inconsistency problem incurred by fraudsters is barely explored, i.e., context inconsistency, feature inconsistency, and relation inconsistency.

In view of the foregoing, various embodiments of the present disclosure provide methods, systems, user devices, and computer program products for detecting fraudulent transactions and assigning one of a fraudulent label or a non-fraudulent label to an unlabeled node from a plurality of nodes associated with a plurality of entities involved in payment transactions. More specifically, the present disclosure describes a server system that is configured to assign one of a fraudulent label or a non-fraudulent label to an unlabeled node from a plurality of nodes associated with a plurality of entities involved in payment transactions. In a non-limiting example, the server system may be a payment server associated with a payment network.

In an embodiment, the server system is configured to access historical payment transaction data from a transaction database. In a non-limiting example, the historical payment transaction data may include both labeled and unlabeled electronic transaction data associated with the plurality of entities. For instance, the plurality of entities may be entities involved in a plurality of transactions. In another embodiment, the server system is configured to extract a plurality of graph features based, at least in part, on the historical payment transaction data. Then, the server system is configured to generate a base graph associated with a plurality of entities based, at least in part, on the plurality of graph features. In one scenario, the base graph may be a homogeneous graph. In a non-limiting example, the base graph may include a plurality of nodes connected via a plurality of edges. In another example, the plurality of nodes may further correspond to a plurality of labeled nodes and a plurality of unlabeled nodes. Such that each node of the plurality of labeled nodes is labeled with one of a fraudulent label or a non-fraudulent label. In some scenarios, the server system may store the base graph in the transaction database.

In another embodiment, the server system is configured to access the base graph associated with a plurality of entities from the transaction database. Then, the server system is configured to assign via a Graph Neural Network (GNN) model, one of the fraudulent label or the non-fraudulent label to each unlabeled node of the plurality of unlabeled nodes based, at least in part, on the base graph. In a non-limiting example, the GNN model may be a Split-Filter-Aggregate Graph Neural Network (SFA-GNN) based model.

In a non-limiting scenario, the labeling assigning step may further include performing a first set of operations. The first set of operations may cause the server system to generate a plurality of sub-graphs based, at least in part, on splitting the base graph. Herein, each sub-graph of the plurality of sub-graphs may include a subset of nodes from the plurality of nodes such that each subset of nodes corresponds to a particular label. In particular, the plurality of sub-graphs may further include a first sub-graph, a second sub-graph, and a third sub-graph. In a non-limiting example, the first sub-graph may include the subset of nodes from the plurality of labeled nodes that are labeled with the fraudulent label. In another non-limiting example, the second sub-graph may include the subset of nodes from the plurality of labeled nodes that are labeled with the non-fraudulent label. In yet another non-limiting example, the third sub-graph may include the subset of nodes from the plurality of unlabeled nodes.

Then, the server system is configured to generate via a Siamese Neural Network (SNN) model, a plurality of filtered sub-graphs based, at least in part, on the plurality of sub-graphs and a set of pre-defined threshold values. In an embodiment, the SNN model may be trained by the server system for filtering the sub-graphs. In particular, for training the SNN model, the server system is configured to perform a second set of operations. The second set of operations includes at first, partitioning the plurality of edges in the base graph into a set of positive pairs and a set of negative pairs. In a non-limiting example, the set of positive pairs can represent or include nodes from the plurality of nodes that have the same labels as each other. In another non-limiting example, the set of negative pairs can represent or include nodes from the plurality of nodes that have different labels from each other. Then, the SNN model is initialized by the server system based, at least in part, on one or more neural network parameters. In a non-limiting example, the SNN model may include a first SNN and a second SNN such that the first SNN and the second SNN are identical to each other. Further, the server system is configured to compute a contrastive loss based, at least in part, on the set of positive pairs, the set of negative pairs, and a contrastive loss function. Furthermore, the server system is configured to update the one or more neural network parameters based, at least in part, on the contrastive loss. It is noted that the one or more neural network parameters may be updated iteratively till the contrastive loss is minimized.

Furthermore, for generating the plurality of filtered sub-graphs, the server system may further be configured to compute via a first SNN of the SNN model, a first output score corresponding to a first node in a corresponding pair connected via a particular edge with a second node for each node in the each sub-graph of the plurality of sub-graphs. Then, the server system is configured to compute via a second SNN of the SNN model, a second output score corresponding to the second node in the corresponding pair connected via the particular edge with the first node for each node in the each sub-graph of the plurality of sub-graphs. Thereafter, the server system is configured to compute a euclidean distance based, at least in part, on the first output score and the second output score. Furthermore, the server system is configured to filter each sub-graph of the plurality of sub-graphs to generate the plurality of filtered sub-graphs based, at least in part, on the each sub-graph of the plurality of sub-graphs to generate the plurality of filtered sub-graphs based, at least in part, on the euclidean distance and a pre-defined threshold value corresponding to the each sub-graph from the set of pre-defined threshold values.

Then, the server system is configured to generate via the GNN model, a plurality of sets of embeddings based, at least in part, on the plurality of filtered sub-graphs. Herein, each set of embeddings of the plurality of sets of embeddings is generated corresponding to each filtered sub-graph of the plurality of filtered sub-graphs. In a non-limiting example, the plurality of sets of embeddings may include a first set of embeddings corresponding to a first filtered sub-graph, a second set of embeddings corresponding to a second filtered sub-graph, and a third set of embeddings corresponding to a third filtered sub-graph.

Then, the server system is configured to generate an aggregated node embedding for each node of the plurality of nodes based, at least in part, on aggregating the plurality of sets of embeddings using an aggregation function.

Then, the server system is configured to generate via a dense layer of the GNN model, a final node representation for each node of the plurality of nodes based, at least in part, on the aggregated node embedding for each node of the plurality of nodes.

Thereafter, the server system is configured to assign one of the fraudulent label or the non-fraudulent label to each unlabeled node of the plurality of unlabeled nodes based, at least in part, on the final node representation for the corresponding unlabeled node. In a non-limiting scenario, for assigning the fraudulent label or the non-fraudulent label, the server system may be configured to at first, compute a final score for each unlabeled node of the plurality of unlabeled nodes based, at least in part, on applying a sigmoid function to the final node representation for the corresponding unlabeled node. Then, if it is determined that the computed final score for the corresponding unlabeled node is at least equal to a pre-defined threshold score, the server system is configured to assign the fraudulent label to the corresponding unlabeled node. Alternatively, if it is determined that the computed final score for the corresponding unlabeled node is lesser than the pre-defined threshold score, then the server system is configured to assign the non-fraudulent label to the corresponding unlabeled node.

In another non-limiting scenario, for assigning the fraudulent label or the non-fraudulent label, the server system may be configured to at first, classify via a classifier such as multi-layer perceptron (MLP), each unlabeled node of the plurality of unlabeled nodes as one of the fraudulent node and the non-fraudulent node based, at least in part, on a classification loss and the final node representation for the corresponding unlabeled node. Then, the server system is configured to assign one of the fraudulent label and the non-fraudulent label to each unlabeled node of the plurality of unlabeled nodes based, at least in part, on the classifying step.

In particular, the server system is configured to address the class imbalance problem using a financial dataset. The server system is configured to implement a proposed novel GNN model that handles the skewness in the class distribution by splitting and sampling a node's full neighborhood into its label-aware sub-neighborhoods. Initially, the GNN model is configured to split the nodes based on their label-aware neighborhoods. Then, the GNN model is configured to filter each neighborhood by using a Siamese network-based sampler (i.e., the SNN model) which calculates a contrastive score for each of the neighbors. The server system is configured to train a Siamese network (i.e., the SNN model) using contrastive loss to calculate a consistency score for a node and each of its neighbors. The neighboring nodes are then sampled based on the consistency score.

Further, the server system is configured to pass the filtered neighborhoods through separate graph neural network (GNN) layers, and then their information is aggregated to obtain the final node embeddings of all nodes of the graph. In some places, the GNN model is also referred to as Split-Filter-Aggregate Graph Neural Network (SFA-GNN) architecture. The SFA-GNN architecture is run on a real-world financial fraud dataset to establish its efficacy in detecting fraud in heavily imbalanced data.

The SFA-GNN architecture presents a neighborhood sampling technique based on node-neighbor consistency using a Siamese network architecture. In addition, the server system is effective in leveraging a large set of unlabeled examples where labeling is quite expensive and time-consuming. It is noted that GNNs are designed to learn in a semi-supervised manner by means of aggregating features from labeled examples as well. However, the label information is not utilized explicitly as most of the known in the art GNN based models do not account for the unlabeled data.

The proposed SFA-GNN model performs explicit utilization of the unlabeled data by treating it as a separate class to allow the SNN-based graph sampler to decide which of the unlabeled nodes it needs to use in the aggregation process.

In a nutshell, the server system is configured to handle class imbalance problems by splitting a node's neighborhood graph into different label-aware sub-graphs, each of which is then sampled by means of a contrastive score. In addition, the server system is configured to implement a neighborhood sampling technique by training a Siamese network on node embeddings utilizing contrastive learning loss. This further allows sampling of consistent neighbors that is useful with nodes having high degrees.

Furthermore, the server system is configured to leverage unlabeled data explicitly and independently by treating it as an unknown class. In one example, the server system is run on a real-world crypto-fraud dataset which has a heavy class imbalance as well as a large set of unlabeled examples.

To that end, the various embodiments of the present disclosure offer multiple advantages and technical effects. For instance, the present disclosure provides a system for fraud detection in electronic payment transactions using graph neural network (GNN) based algorithms. In addition, the system tackles class imbalance problems by splitting a node's neighborhood into different label-aware neighborhoods. Further, the system employs a neighborhood sampler based on feature similarity allowing sampling of consistent neighbors that is particularly useful in the case of high-degree nodes. Furthermore, the system leverages unlabeled data explicitly and independently by treating it as an unknown class. Moreover, the system is robust to GNN-based adversarial attacks.

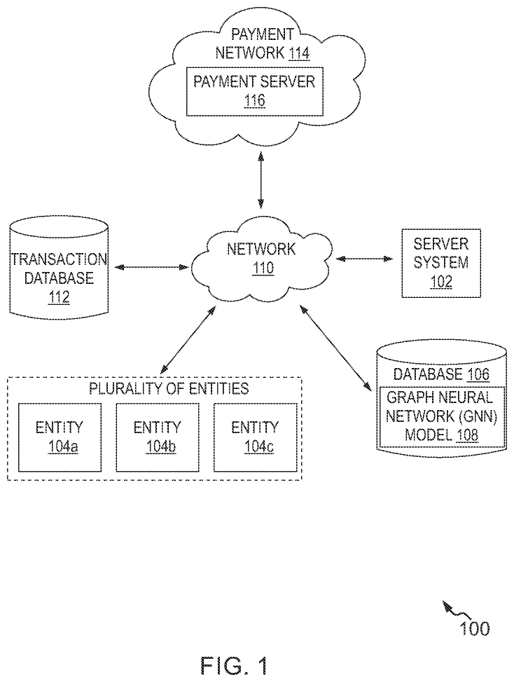

Various embodiments of the present disclosure are described hereinafter with reference to FIGS. 1 to 9.

FIG. 1 illustrates an exemplary representation of an environment 100 related to at least some embodiments of the present disclosure. Although the environment 100 is presented in one arrangement, other embodiments may include the parts of the environment 100 (or other parts) arranged otherwise depending on, for example, training a graph neural network (GNN) model for performing fraud detection in electronic payment transactions. The environment 100 generally includes a server system 102, a plurality of entities 104a, 104b, and 104c, a database 106 storing a graph neural network (GNN) model 108, a transaction database 112, and a payment network 114 including a payment server 116, each coupled to, and in communication with (and/or with access to) a network 110. The network 110 may include, without limitation, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, a virtual network, and/or another suitable public and/or private network capable of supporting communication among the entities illustrated in FIG. 1, or any combination thereof.

Various entities in the environment 100 may connect to the network 110 in accordance with various wired and wireless communication protocols, such as Transmission Control Protocol and Internet Protocol (TCP/IP), User Datagram Protocol (UDP), 2^{nd} Generation (2G), 3^{rd} Generation (3G), 4^{th} Generation (4G), 5^{th} Generation (5G) communication protocols, Long Term Evolution (LTE) communication protocols, any combination thereof or any future communication protocols. For example, the network 110 may include multiple different networks, such as a private network or a public network (e.g., the Internet, etc.) through which the server system 102 and the payment server 116 may communicate.

In an embodiment, the plurality of entities 104a-104c may include individual entities that may be associated or connected to each other via some relationship. In various non-limiting examples, the plurality of entities 104a-104c may correspond to a plurality of payment accounts, a plurality of payment cards, a plurality of payment wallets, a plurality of financial wallets, a plurality of financial accounts, a plurality of cardholders, a plurality of merchants, and the like. In addition, each entity of the plurality of entities 104a-104c may be associated or has some relationship with another entity of the plurality of entities 104a-104c. In one implementation, each entity of the plurality of entities 104a-104c may perform a payment transaction with another entity of the plurality of entities 104a-104c.

In an example, a payment account P1 may have transacted with a payment account P2. More specifically, a payment amount (i.e., monetary value) may have been debited from the payment account P1 and credited into the payment account P2. In another example, a payment account P3 may have transacted with a payment wallet W1. More specifically, a payment amount (i.e., monetary value) may have been debited from the payment account P3 and credited into the payment wallet W1. In yet another example, a payment wallet W2 may have transacted with a payment wallet W3. More specifically, a payment amount (i.e., monetary value) may have been debited from the payment wallet W2 and credited into the payment wallet W3.

In an example, electronic transactions can be performed via various user devices (not shown in the figures). In various examples, the user devices may include electronic devices such as, but not limited to, personal computers (PCs), tablets, Personal Digital Assistants (PDAs), voice-activated assistants, Virtual Reality (VR) devices, smartphones, laptops, and the like. In another example, electronic transactions can be performed via payment cards (e.g., “swipe” or present a payment card) at a POS terminal.

In an example, the plurality of payment accounts may be associated with a plurality of users/cardholders (not shown in figures). In another example, the plurality of payment accounts may be associated with a plurality of merchants (not shown in figures). In addition, the plurality of payment accounts associated with the plurality of users may be managed by an issuer server (not shown in the figures) associated with an issuing bank of the plurality of users. Further, the plurality of payment accounts associated with the plurality of merchants may be managed by an acquirer server (not shown in the figures) associated with an acquiring bank of the plurality of merchants.

In an implementation, the issuer server may be a computing server that is associated with an issuer bank (or issuing bank). The issuer bank is a financial institution that manages the accounts of multiple users. Account details of the accounts established with the issuer bank are stored in user profiles of the users in a memory of the issuer server or on a cloud server associated with the issuer server.

In another implementation, the acquirer server is associated with a financial institution (e.g., a bank) that processes financial transactions for merchants. This can be an institution that facilitates the processing of payment transactions for physical stores, or merchants, or an institution that owns platforms that make online purchases or purchases made via software applications possible (e.g., shopping cart platform providers and in-app payment processing providers).

In one embodiment, the transaction database 112 is communicatively coupled to the server system 102. The transaction database 112 may store historical and/or real-time transaction data associated with the plurality of entities 104a-104c. In various non-limiting examples, the transaction data may include, but is not limited to, transaction attributes, such as transaction amount, source of funds such as a bank, wallet, or payment cards, transaction channel used for loading funds (such as point of sale (POS) terminal or automated teller machine (ATM)), transaction velocity features such as count and transaction amount sent in the past x days to a particular user, transaction location information, external data sources, and other relevant internal data to associated with each transaction.

In another example, the transaction database 112 may include information related to a plurality of electronic transactions performed between the plurality of entities 104a-104c. For example, the transaction database 112 may include information related to both fraudulent transactions and non-fraudulent transactions. In addition, the transaction database 112 may include timestamp information and location information associated with each of the plurality of electronic transactions as well.

In various non-limiting examples, the transaction database 112 may further include multifarious data, including, for example, social media data, Know Your Customer (KYC) data, payment transaction data, trade data, employee data, Anti Money Laundering (AML) data, market abuse data, Foreign Account Tax Compliance Act (FATCA) data, fraud transaction data, and the like.

For example, the transaction database 112 may store user profile data associated with the user. The user profile data may include account balance, credit line, details of the user, account identification information, payment account details, and the like. In addition, the user profile data may also include information related to the user such as the name of the user, age of the user, gender of the user, physical attributes, location, registered contact number, family information, alternate contact number, registered e-mail address, and the like.

The server system 102 is configured to perform one or more of the operations described herein. In one non-limiting example, the server system 102 is the payment server 116. The server system 102 is a separate part of the environment 100 and may operate apart from (but still in communication with, for example, via the network 110, the payment server 116, and any third-party external servers (to access data to perform the various operations described herein)). However, in other embodiments, the server system 102 may actually be incorporated, in whole or in part, into one or more parts of the environment 100, for example, the payment server 116. In addition, the server system 102 should be understood to be embodied in at least one computing device in communication with the network 110, which may be specifically configured, via executable instructions, to perform as described herein, and/or embodied in at least one non-transitory computer-readable media.

In one implementation, the database 106 is communicably coupled to the server system 102. The database 106 provides a storage location for the GNN model 108. The server system 102 may be a computing server configured to implement the GNN model 108 to perform fraud detection. The server system 102 is initially configured to define or generate a base graph (e.g., homogeneous graph, etc.) including the plurality of entities 104a-104c. The plurality of entities 104a-104c may be represented via a plurality of nodes. Further, edges between the plurality of nodes may represent electronic transactions performed between the plurality of entities 104a-104c. The server system 102 is then configured to determine fraudulent and/or non-fraudulent nodes based, at least in part, on the execution of the GNN model 108.

In one embodiment, the payment network 114 may be used by the payment card issuing authorities as a payment interchange network. Examples of payment interchange networks include but are not limited to, Mastercard® payment system interchange network. The Mastercard® payment system interchange network is a proprietary communications standard promulgated by Mastercard International Incorporated® for the exchange of electronic payment transaction data between issuers and acquirers that are members of Mastercard International Incorporated®. (Mastercard is a registered trademark of Mastercard International Incorporated located in Purchase, N.Y.).

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices. Additionally, or alternatively, a set of systems (e.g., one or more systems) or a set of devices (e.g., one or more devices) of the environment 100 may perform one or more functions described as being performed by another set of systems or another set of devices of the environment 100.

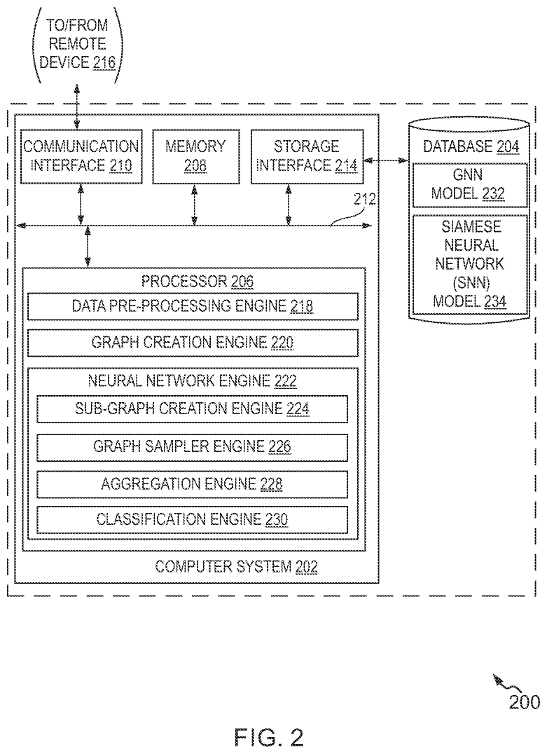

Referring now to FIG. 2, a simplified block diagram of a server system 200 is shown, in accordance with an embodiment of the present disclosure. The server system 200 is an example of the server system 102. In some embodiments, the server system 200 is embodied as a cloud-based and/or SaaS-based (software as a service) architecture.

The server system 200 includes a computer system 202 and a database 204. The computer system 202 includes at least one processor 206 for executing instructions, a memory 208, a communication interface 210, and a storage interface 214 that communicates with each other via a bus 212.

In some embodiments, the database 204 is integrated within the computer system 202. For example, the computer system 202 may include one or more hard disk drives as the database 204. The storage interface 214 is any component capable of providing the processor 206 with access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204. In some implementations, the database 204 is an example of the database 106 or the transaction database 112. The database 204 is configured to store a Graph Neural Network (GNN) model 232 and a Siamese Neural Network (SNN) model 234. It is noted that the GNN model 232 is an example of the GNN model 108 of FIG. 1.

Examples of the processor 206 include, but are not limited to, an application-specific integrated circuit (ASIC) processor, a reduced instruction set computing (RISC) processor, a complex instruction set computing (CISC) processor, a field-programmable gate array (FPGA), and the like. The memory 208 includes suitable logic, circuitry, and/or interfaces to store a set of computer-readable instructions for performing operations. Examples of the memory 208 include a random-access memory (RAM), a read-only memory (ROM), a removable storage drive, a hard disk drive (HDD), and the like. It will be apparent to a person skilled in the art that the scope of the disclosure is not limited to realizing the memory 208 in the server system 200, as described herein. In another embodiment, the memory 208 may be realized in the form of a database server or cloud storage working in conjunction with the server system 200, without departing from the scope of the present disclosure.

The processor 206 is operatively coupled to the communication interface 210 such that the processor 206 is capable of communicating with a remote device 216 such as, the payment server 116, or communicating with any entity connected to the network 110 (as shown in FIG. 1). In one embodiment, the processor 206 is configured to access labeled historical electronic transaction data associated with the plurality of entities 104a-104c from the transaction database 112.

It is noted that the server system 200 as illustrated and hereinafter described is merely illustrative of an apparatus that could benefit from embodiments of the present disclosure and, therefore, should not be taken to limit the scope of the present disclosure. It is noted that the server system 200 may include fewer or more components than those depicted in FIG. 2.

In one implementation, the processor 206 includes a data pre-processing engine 218, a graph creation engine 220, and a neural network engine 222. The neural network engine 222 may further include a sub-graph creation engine 224, a graph sampler engine 226, an aggregation engine 228, and a classification engine 230. It should be noted that components, described herein, such as the data pre-processing engine 218, the graph creation engine 220, the neural network engine 222, the sub-graph creation engine 224, the graph sampler engine 226, the aggregation engine 228, and the classification engine 230 can be configured in a variety of ways, including electronic circuitries, digital arithmetic and logic blocks, and memory systems in combination with software, firmware, and embedded technologies.

In an embodiment, the data pre-processing engine 218 includes suitable logic and/or interfaces for accessing labeled and/or unlabeled electronic transaction data associated with the plurality of entities 104a-104c from the transaction database 112. The electronic transaction data may be associated with electronic payment transactions performed by the plurality of entities 104a-104c in a period of time (e.g., weekly, monthly, annually, etc.). In an example, the electronic transaction data for each electronic transaction may include, but is not limited to, a merchant name identifier, a unique merchant identifier, a timestamp, geolocation data, and information related to the payment instrument involved in the electronic transaction.

In one implementation, the data pre-processing engine 218 is configured to receive a list of labeled payment instruments (for example, payment cards, payment accounts, payment wallets, etc.) associated with the plurality of entities 104a-104c from a third-party server or the payment server 116. The term “labeled payment instruments” herein represents payment instruments with a label on whether a payment instrument is a fraudulent payment instrument or a non-fraudulent payment instrument. In an embodiment, the electronic transaction data includes historical transaction data of electronic transactions performed by the plurality of entities 104a-104c in the past. In another embodiment, the electronic transaction data includes real-time transaction data of electronic transactions performed by or performed between the plurality of entities 104a-104c.

In one implementation, the data-preprocessing engine 218 is configured to perform operations (such as data-cleaning, normalization, feature extraction, and the like) on the electronic transaction data. In an example, the data pre-processing engine 218 may eliminate the fraudulent transaction data for the payment instruments (e.g., payment cards, payment wallets, etc.) that have been reported as lost or stolen.

In an example, the data pre-processing engine 218 may extract the electronic transaction data associated with the payment accounts of the plurality of entities 104a-104c. In another example, the data pre-processing engine 218 may extract the electronic transaction data associated with the payment wallets of the plurality of entities 104a-104c. The electronic transaction data may include information related to fraudulent and/or non-fraudulent electronic transactions performed via payment instruments associated with the plurality of entities 104a-104c.

In one implementation, the data pre-processing engine 218 may use natural language processing (NLP) algorithms to extract a plurality of graph features based, at least in part, on the electronic transaction data. The plurality of graph features is then used to define the base graph. The plurality of graph features may include geolocation data associated with the fraudulent payment instruments, population density, transaction velocity (i.e., frequency of electronic transactions), historical fraudulent electronic transaction data, and electronic transaction history. In an example, the geolocation data associated with fraudulent electronic transactions may include data associated with the identification or estimation of the real-world geographic location of the user device (such as mobile device, web-based computer, processing device, etc.).

In an embodiment, the graph creation engine 220 includes suitable logic and/or interfaces for defining or generating the base graph based, at least in part, on the plurality of graph features identified from the electronic transaction data. In one non-limiting example, the base graph is a homogeneous graph. The base graph represents a computer-based graph representation of the plurality of entities 104a-104c as nodes. In one example, the plurality of entities 104a-104c may represent the plurality of payment instruments. In addition, relationships between the nodes are represented as edges. The edges represent payment transactions performed between the plurality of payment instruments.

In another embodiment, the graph creation engine 220 may generate the base graph that associates the plurality of nodes (i.e., the plurality of payment instruments) with each other using one or more relationships (i.e., edges). More specifically, the base graph may include the nodes (e.g., payment instruments) and edges (e.g., payment transactions). In one embodiment, the base graph is a node-based structure including the plurality of nodes. In one example, the plurality of nodes is connected with each other using respective edges.

Additionally, the base graph may include metadata associated with the plurality of nodes, and/or information identifying relationships (such as, for example, electronic transactions, fraud connections, etc.) among the plurality of nodes. In one example, the fraud connection may represent fraud activities performed between a plurality of payment instruments in the past time.

In some implementations, the plurality of nodes of the base graph may be labeled or unlabeled. The “labeled nodes” herein represent those nodes that are labeled i.e., payment instruments that are known to be either fraudulent or non-fraudulent. The “unlabeled nodes” herein represent those nodes that are unlabeled i.e., payment instruments that are not known to be fraudulent or non-fraudulent. In addition, the base graph may get modified with time. For example, edges and/or nodes may be added or removed from the base graph with time based on electronic transactions performed via the plurality of payment instruments.

In an embodiment, the neural network engine 222 includes suitable logic and/or interfaces for implementing or running the GNN model 232 to perform fraud detection. In particular, the neural network engine 222 is configured to identify labels for the unlabeled nodes of the base graph. More specifically, the neural network engine 222 is configured to determine whether a particular node of the base graph is fraudulent or non-fraudulent.

In one implementation, the neural network engine 222 is configured to train the Siamese neural network (SNN) model 234 based on a labeled base graph. The labeled base graph is a computer-based graph representation of nodes having a label associated with each node. In one example, the label may include fraudulent or non-fraudulent. For example, the labeled base graph may include all the nodes that may be either fraudulent or non-fraudulent.

In addition, the neural network engine 222 is configured to train the SNN model 234 on a set of positive and negative pairs. In an example, positive pairs may represent nodes that have the same label and negative pairs may represent nodes that have different labels. In addition, the edges of the base graph may be partitioned into positive and negative pairs. In one non-limiting example, the SNN model 234 is trained based on a contrastive loss function. The contrastive loss function facilitates the learning of embeddings in which two similar nodes have a low Euclidean distance and two dissimilar nodes have a large Euclidean distance.

In an embodiment, the sub-graph creation engine 224 includes suitable logic and/or interfaces for generating a plurality of sub-graphs based, at least in part, on the base graph. In one implementation, the sub-graph creation engine 224 is configured to generate three sub-graphs for the base graph. In one example, the base graph is a computer-based graph representation of a node ‘n’ and all its neighboring nodes i.e., nodes that are directly connected with the node ‘n’. In addition, the neighboring nodes may include labeled nodes (i.e., nodes that are either labeled as fraudulent or non-fraudulent) or unlabeled nodes.

In this example scenario, the sub-graph creation engine 224 is configured to segment or divide the base graph into three sub-graphs—sub-graph 1, sub-graph 2, and sub-graph 3. A first sub-graph of the three sub-graphs (e.g., sub-graph 1) may include the node ‘n’ and all its neighboring nodes that are labeled as fraudulent. A second sub-graph of the three sub-graphs (e.g., sub-graph 2) may include the node ‘n’ and all its neighboring nodes that are labeled as non-fraudulent. A third sub-graph of the three sub-graphs (e.g., sub-graph 3) may include the node ‘n’ and all its neighboring nodes that are unlabeled.

In an embodiment, the graph sampler engine 226 includes suitable logic and/or interfaces for generating a plurality of filtered sub-graphs from the plurality of sub-graphs based, at least in part, on the Siamese neural network (SNN) model 234. In particular, the graph sampler engine 226 is configured to pass each sub-graph of the plurality of sub-graphs through an SNN-based graph sampler. Therefore, the graph sampler engine 226 is configured to pass the three sub-graphs through three different SNN-based graph samplers. The SNN-based graph samplers are then configured to output the plurality of filtered sub-graphs.

In particular, the SNN-based graph samplers (i.e., the SNN model 234) generate the plurality of filtered sub-graphs based, at least in part, on a plurality of threshold values set for the different SNN-based graph samplers. In one implementation, a first threshold value is set for a first SNN-based graph sampler. In addition, a second threshold value is set for a second SNN-based graph sampler, and a third threshold value is set for a third SNN-based graph sampler. In one embodiment, different threshold values are used for each neighborhood to under-sample the majority class and over-sample the minority class.

More specifically, the graph sampler engine 226 is configured to compute a score for each neighboring node of the node ‘n’. The computed score is then compared with the threshold value pre-defined for the particular SNN-based graph sampler. If the computed score is greater than or equal to the pre-defined threshold value, then the node is present in the filtered sub-graph; otherwise, if the computed score is lesser than the pre-defined threshold value, then the node is removed from the filtered sub-graph. Similarly, the graph sampler engine 226 is configured to filter the plurality of sub-graphs based on the individual pre-defined threshold values for the different SNN-based graph samplers.

In one embodiment, the pre-defined threshold values are set as hyper-parameters and can be modified as per the requirement. In various non-limiting examples, the pre-defined threshold values set for the different SNN-based graph samplers are 0.005, 0.0005, and 0.001. However, the pre-defined threshold values may vary as per the requirement.

In another embodiment, the neural network engine 222 is then configured to pass each filtered sub-graph of the plurality of filtered sub-graphs through a graph convolutional network (GCN) layer. Therefore, for three filtered sub-graphs, the neural network engine 222 is configured to pass the three filtered sub-graphs through three different GCN layers. The neural network engine 222 is configured to generate a plurality of sets of embeddings for the plurality of sub-graphs based, at least in part, on GCN layers. In one implementation, the plurality of sets of embeddings includes a first set of embeddings corresponding to the first filtered sub-graph, a second set of embeddings corresponding to the second filtered sub-graph, and a third set of embeddings corresponding to the third filtered sub-graph.

In one implementation, the neural network engine 222 passes the first filtered sub-graph through a first GCN layer to generate the first set of embeddings. In addition, the neural network engine 222 passes the second filtered sub-graph through a second GCN layer to generate the second set of embeddings. Further, the neural network engine 222 passes the third filtered sub-graph through a third GCN layer to generate the third set of embeddings.

In an embodiment, the aggregation engine 228 includes suitable logic and/or interfaces for generating a final node representation for the node ‘n’ based, at least in part, on an aggregation of the plurality of sets of embeddings. More specifically, the aggregation engine 228 is configured to aggregate the first set of embeddings, the second set of embeddings, and the third set of embeddings based, at least in part, on an aggregation function to generate the final node representation of each node (e.g., node ‘n’) of the base graph. In some non-limiting examples, the aggregation function may be mean, max, concat, attention, and the like.

In another embodiment, the aggregation engine 228 is also configured to pass the final node representation for each node through a dense layer. Generally, the “dense layer” corresponds to a simpler layer of neurons that is deeply connected with its preceding layer i.e., neurons of the dense layer are deeply connected to every neuron of its preceding layer. After passing the final node representation through the dense layer, the aggregation engine 228 is configured to apply a sigmoid function over the final node representation to compute a final score having a value in a range of 0 to 1.

In an embodiment, the classification engine 230 includes suitable logic and/or interfaces for classifying each node of the plurality of nodes in the base graph as either fraudulent or non-fraudulent. In one implementation, the classification engine 230 is configured to classify each node of the base graph as either fraudulent or non-fraudulent based at least in part on the computed final score. In one exemplary implementation, the classification engine 230 may compare the computed final score with a pre-defined threshold score. If the computed final score is at least equal (i.e., greater than or equal) to the pre-defined threshold score, the classification engine 230 is configured to classify the node as a fraudulent node; otherwise, if the computed final score is lesser than the pre-defined threshold score, the classification engine 230 is configured to classify the node as a non-fraudulent node.

In this manner, the classification engine 230 is configured to classify all the unlabeled nodes of the base graph. In other words, the classification engine 230 is configured to output a labeled base graph with labels fraudulent or non-fraudulent for each node of the base graph.

In one implementation, the classification engine 230 is configured to train a classification model based, at least in part, on a classification loss. In one non-limiting example, the classification loss is a cross-entropy (CE) loss. The classification model may correspond to a multi-layer perceptron (MLP) having various MLP layers. The classification model is configured to classify each node as either fraudulent or non-fraudulent.

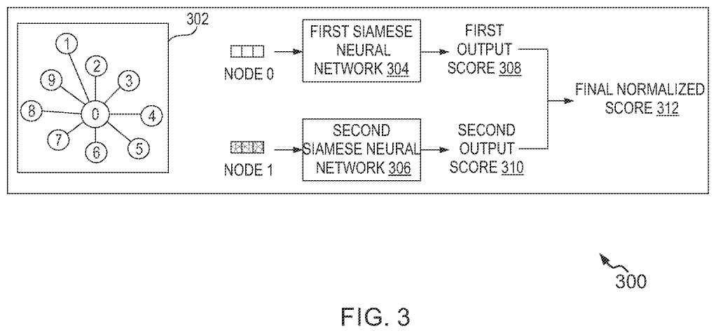

FIG. 3 is a block diagram representation 300 of the training of a Siamese Neural Network (SNN) model 234, in accordance with an embodiment of the present disclosure.

As explained above, the processor 206 is configured to train the Siamese neural network (SNN) model 234 based, at least in part, on a labeled base graph. In one implementation, the trained SNN model 234 may then be used as the SNN-based graph sampler during the implementation phase. Generally, a Siamese neural network is an artificial neural network that includes two or more identical sub-networks. The term “identical” herein represents that the two sub-networks have the same configuration with the same one or more neural network parameters (e.g., weights, biases, etc.).

With reference to FIG. 3, a labeled base graph 302 is shown. For the sake of simplicity, the labeled base graph 302 includes a central node ‘0’ and other neighboring nodes (labeled from ‘1’ to ‘9’) connected with the central node ‘0’. The edges of the base graph 302 represent electronic transactions performed between the central node ‘0’ and the neighboring nodes. In an example, an edge between the central node ‘0’ and neighboring node ‘1’ represents an electronic transaction performed between the node ‘0’ and ‘1’. In addition, the nodes may represent payment instruments including, for example, payment accounts, payment cards, payment wallets, and the like. Further, in the base graph 302, the nodes may be labeled as fraudulent nodes or non-fraudulent nodes since the base graph 302 is a labeled base graph. The SNN model 234 is trained based on the labeled base graph 302.

In one implementation, the processor 206 is configured to partition the edges of the base graph into positive and negative pairs. If two nodes have the same labels, the nodes can be considered positive pairs. If two nodes have different labels, the nodes can be considered negative pairs. With reference to FIG. 3, the processor 206 is configured to train the SNN model 234 on the set of positive pairs and negative pairs. In an example, features corresponding to node ‘0’ are fed as an input to a first Siamese neural network of the SNN model 234 (see, 304). In parallel, features corresponding to node ‘1’ are fed as input to a second Siamese neural network of the SNN model 234 (see, 306). The first Siamese NN and the second Siamese NN are identical twins sharing the same configuration and the same one or more neural network parameters.

The first Siamese NN is configured to output a first output score (see, 308) based on the features of the node ‘0’. Similarly, the second Siamese NN is configured to output a second output score (see, 310) based on the features of the node ‘1’. The processor 206 is then configured to calculate a final normalized score. Mathematically, the final normalized score ‘s’ for two nodes ‘u’ and ‘v’ may be calculated as: s(u, v)=e\hat{ }(−Euclidean distance (output 1, output 2)) (see, 312).

In one non-limiting example, the SNN model 234 is trained based on a contrastive loss function. The contrastive loss function enables the SNN model 234 to learn embeddings in which two similar points or nodes have a low Euclidean distance and two dissimilar points have a large Euclidean distance. Additionally, the final normalized score for each node and each of the neighbor nodes may be calculated as: s (u, v)/(sum(s(u, v)) over neighbors, where u and v represent nodes and s represents the normalized score.

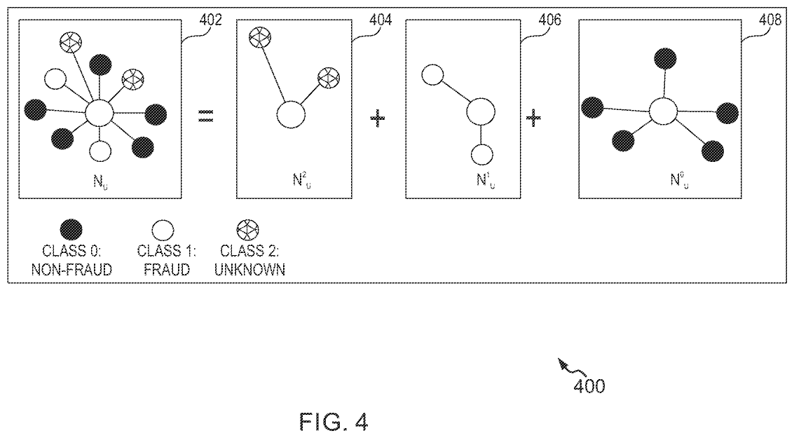

FIG. 4 is an exemplary block diagram representation 400 of the generation of a plurality of sub-graphs from a base graph, in accordance with an embodiment of the present disclosure.

As explained above, the processor 206 is configured to generate the plurality of sub-graphs from the base graph. With reference to FIG. 4, a base graph 402 is shown. The base graph 402 may be represented as Nᵤ. As depicted, the base graph 402 includes labeled nodes and unlabeled nodes connected to a central node. In addition, the central node may either be labeled or unlabeled as well. In an implementation, the labeled nodes may then be classified as class 0: non-fraudulent nodes and class 1: fraudulent nodes. Further, the unlabeled nodes may be considered as class 2: unknown class.

The processor 206 is then configured to generate the plurality of sub-graphs from the base graph 402. As shown in FIG. 4, the processor 206 is configured to generate three sub-graphs for three classes from the base graph 402. The processor 206 is configured to generate a first sub-graph 404. The first sub-graph 404 may be represented as Nᵤ². In one example, the first sub-graph 404 is a computer-based graph representation of all unlabeled nodes connected with the central node i.e., nodes connected with the central node that are not labeled as fraudulent or non-fraudulent.

In addition, the processor 206 is configured to generate a second sub-graph 406. The second sub-graph 406 may be represented as Nᵤ¹. In one example, the second sub-graph 406 is a computer-based graph representation of all labeled fraudulent nodes connected with the central node i.e., nodes connected with the central node that are labeled as fraudulent nodes. Further, the processor 206 is configured to generate a third sub-graph 408. The third sub-graph 408 may be represented as Nᵤ⁰. In one example, the third sub-graph 408 is a computer-based graph representation of all labeled non-fraudulent nodes connected with the central node i.e., nodes connected with the central node that are labeled as non-fraudulent nodes.

In some implementations, the processor 206 is further configured to under-sample the majority class (i.e., the non-fraudulent nodes) and over-sample the minority class (i.e., the fraudulent nodes) based on the individual SNN models (i.e., the trained Siamese NN-based graph samplers). As described earlier, the trained SNN-based graph samplers perform this under-sampling and over-sampling using the plurality of threshold values set for the different SNN-based graph samplers. In one implementation, a first threshold value is set for a first SNN-based graph sampler. In addition, a second threshold value is set for a second SNN-based graph sampler, and a third threshold value is set for a third SNN-based graph sampler. To that end, different threshold values are used for each neighborhood to under-sample the majority class and over-sample the minority class.

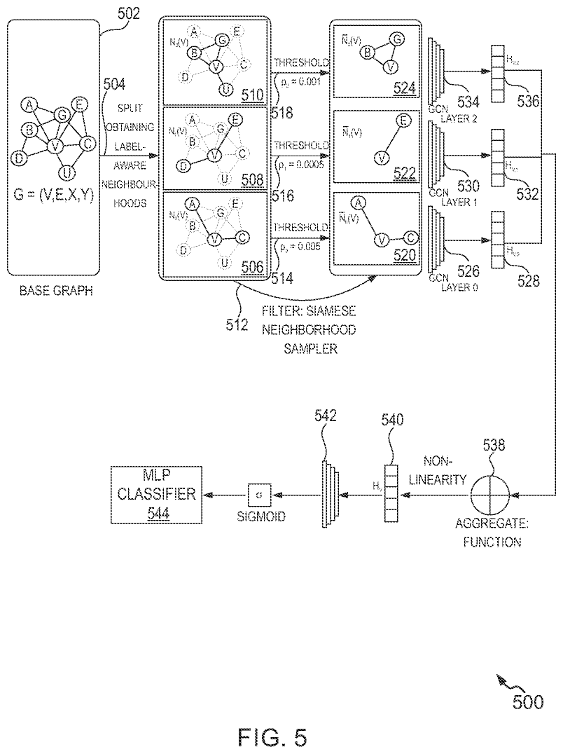

FIG. 5 is a schematic representation 500 of the implementation of the graph neural network (GNN) model 232 to label unlabeled nodes in a base graph, in accordance with an embodiment of the present disclosure.

With reference to FIG. 5, a base graph 502 is shown. The base graph 502 can be represented as G=(V, E, X, Y), where V={v₁, . . . , v_{N}} represents a set of N nodes. E represents a set of edges. In addition, the edge between node u, v∈V can be denoted as (u, v) ∈E. X={x₁, x₂, . . . , x_{N}} denotes the features of nodes and Y={y₁, . . . , y_{N}} represents the labels of nodes. Let K denote the total class number.

The objective is to learn a representation vector hᵥ and a mapping function f (⋅) to predict the class label yᵥ of node v i.e., ŷᵥ=f(hᵥ). It is noted that Graph-based fraud detection problems using graph, G can be treated as a node classification task. Each node vᵢ∈V has a label yᵢ. In general, K=2, i.e., yᵢ=0 for fraud and yᵢ=1 for non-fraud. In the training dataset, there are few nodes with no prior label. Such an unlabeled set of nodes is treated as a separate third category labeled as “unknown”. However, at the time of training, the loss is calculated only for the previously labeled nodes alone.

In one implementation, the base graph 502 is generated based on historical electronic transaction data accessed from a training dataset. In an example, the training dataset may be accessed from the transaction database 112. The base graph 502 can be considered as an input. The base graph 502 includes three different types of nodes—fraudulent nodes, non-fraudulent nodes, and unlabeled or unknown nodes. It is to be noted that one of the objectives of the GNN model 232 is to find or predict the labels for the unlabeled nodes.

The edges between the nodes represent the electronic transactions performed between the two nodes (e.g., two parties or two payment accounts, etc.). The processor 206 is then configured to split the base graph 502 into label-aware neighborhoods Nₖ(v), where v represents an example node under consideration i.e., v∈{unknown, fraud, non-fraud} and k is its label (see, 504).

In particular, the processor 206 is configured to create K separate neighborhoods corresponding to each class. It is noted that the idea is to utilize the already available label information and create different neighborhoods for each node such that the neighbors for each node belong to just one class. For the node classification task, the probability of correctly classifying a node can be enhanced by increasing the positive ratio of each node. Additionally, a positive ratio of a node can be defined as the ratio of same-label neighbors to total neighbors. More specifically, in the imbalanced data setting, most neighbors of a node will belong to the majority class, leading to features of the minority class getting overlooked during the message aggregation step of the GNN model 232. Therefore, the neighborhood of the node v i.e., Nᵥ is split into K separate label-aware neighborhoods.

Mathematically, the neighborhood set of v can be defined as:

N(v)={vᵢ∈V|(v, vᵢ)∈E} Eqn. (1)

Further, the processor 206 is configured to split the neighborhood of node v, N(v) into K different neighborhoods N₁(v), N₂(v), Nₖ(v), corresponding to K class labels using equation 2.

Nₖ(v)={vᵢ∈N(v)|y_{i=k}} Eqn. (2)

For the fraud detection problem, in a non-limiting scenario, the value of k is assumed as 3 and therefore, the processor 206 splits the neighborhood into licit, illicit, and unknown neighbors, where the unknown nodes can include both the unlabeled nodes and test examples. With reference to FIG. 5, the base graph 502 is split into three sub-graphs, denoted as N₀(v) (see, 506), N₁(v) (see, 508), and N₂(v) (see, 510). In addition, N₀(v) represents a sub-graph denoting only unlabeled nodes connected with the node v. N₁(v) represents a sub-graph denoting only fraudulent nodes connected with the node v. N₂ (v) represents a sub-graph denoting only non-fraudulent nodes connected with the node v. N₀(v), N₁(v), and N₂(v) shows three different sub-graphs post-splitting according to a respective label-aware neighborhood of node v.

Furthermore, the processor 206 is configured to filter the label-aware neighborhoods based, at least in part, on the pre-trained SNN-based graph samplers (e.g., the SNN model 234) (see, 512). In particular, the processor 206 is configured to calculate feature similarity and filter the neighborhoods based on threshold values ρₖ. It is to be noted that it is inappropriate to aggregate information from all neighbors of a node, specifically in cases where the target variable is unbalanced. Therefore, the processor 206 is configured to refine the sub-graph structure by selecting a subset of neighbors to aggregate information from the neighbors.

To filter neighbors for node v, the processor 206 is configured to assign a score to each of the connecting edges. This score then represents how far the feature vectors of the two connected nodes are in the latent space. The vectors that are close by represent that the nodes belong to the same class and vice versa. To achieve this, the processor 206 is configured to leverage the SNN model 234 to project the embeddings of a pair including a node and its corresponding neighbors into the latent space such that the embeddings are more similar if both node and its neighbors belong to the same class and less similar embeddings if the classes are different.

In particular, a pair of nodes (v, u) is referred to as positive pair when u and v belong to the same class and a negative pair when u and v belong to a different class. The SNN model 234 includes two identical parallel networks of two hidden layers sharing the same weights and architecture. One of the networks in the SNN model 234 takes input as Xᵥ and the other takes input as Xᵤ. Then, the processor 206 is configured to calculate the Euclidean distance D_{W} between the output from each of the networks. Mathematically, the contrastive loss may be calculated as:

$$Loss = ( 1 - y ) \frac{1}{2} {( {D}_{W} )}^{2} + ( y ) \frac{1}{2} {\{ max ( 0 , m - {D}_{W} ) \}}^{2} \qquad Eqn . ( 3 )$$

Where m is a hyperparameter called margin and y will take the value as 0 when the pair (v, u) is a positive pair and 1 when the pair (v, u) is a negative pair. If input pairs are dissimilar, and the distance is greater than the margin, then no loss is incurred. The SNN model 234 is thus trained to learn weights to minimize the contrastive loss defined above.

Since the objective is to aggregate information from only selective neighbors, a constraint is added to the neighborhood of each node to filter neighbors. In particular, a score is defined for a pair of nodes and its neighbors, and only those neighbors are kept that have a normalized score greater than a fixed threshold value. Mathematically, a score function for a pair of nodes v and u can be calculated as:

S(v, u)=e^{-∥F(X}^{ᵥ}^{,X}^{ᵤ}^{)∥}^{₂}² Eqn. (4)

Where, F (Xᵥ, Xᵤ) denotes a Siamese network trained based on contrastive loss. The SNN model 234 takes feature vectors of nodes v and u, and then transforms them to provide two outputs. Further, Euclidean distance is calculated between two outputs of F (Xᵥ, Xᵤ). Furthermore, a normalized score is defined for a pair (v, u) obtained through Equation (4) over neighbors of v, Nₖ(v) using Equation (5).

$${S}_{n} ( v , u ) = \frac{S ( v , u )}{{\sum }_{u ∈ {N}_{k} ( v )} S ( v , u )} , ∀ u ∈ {N}_{k} ( v ) \qquad Eqn . ( 5 )$$

Since the node neighborhood is initially split into label-aware neighborhoods and then filtering is applied, Equation (6) can be used to get filtered neighbors set of a node v (denoted by N̅ₖ̅(v)).

N̅ₖ̅(v)={u∈Nₖ(v)|Sₙ(v,u)>ρₖ} Eqn. (6)

Where Sₙ(v, u) is a normalized score function. Therefore, it can be easily shown that N̅ₖ̅(v)⊆Nₖ(v). Furthermore, it is to be noted that the threshold value of the normalized score (ρₖ), above which the neighbors are retained, is different for each k. Moreover, ρₖ takes value in such a manner that the majority class has the highest value, and the minority class has the lowest value. In the fraud detection setting, when K=2, since there are far fewer data points of the fraud class, the magnitude of ρ_{fraud} is than that of ρ_{non-fraud}. This allows under-sampling of the nodes belonging to the majority class. Also, the filtered neighbor set Nₖ(v) is achieved using Equation (6).

With reference to FIG. 5, ρ₀ denotes the threshold value for filtering of the sub-graph N₀(v) (see, 514). In addition, ρ₁ denotes the threshold value for filtering of the sub-graph N₁(v) (see, 516). Further, ρ₂ denotes the threshold value for filtering of the sub-graph N₂ (v) (see, 518). In some non-limiting examples, the value of ρ₀ is pre-defined as 0.005, the value of ρ₁ is pre-defined as 0.0005, and the value of ρ₂ is pre-defined as 0.001. The values of ρ₀, ρ₁, and ρ₂ are set as hyper-parameters and can be changed as per requirement.

As explained above, the SNN model 234 is configured to generate three filtered sub-graphs from the three sub-graphs. With reference to FIG. 5, the processor 206 is configured to generate a filtered sub-graph N̅₀̅(v) (see, 520) from the sub-graph N₀(v) based, at least in part, on the implementation of the SNN-based graph sampler (i.e., the SNN model 234). Similarly, the processor 206 is configured to generate a filtered sub-graph N̅₁̅(v) (see, 522) from the sub-graph N₁(v) based, at least in part, on the implementation of the SNN-based graph sampler (i.e., the SNN model 234). Also, the processor 206 is configured to generate a filtered sub-graph N̅₂̅(v) (see, 524) from the sub-graph N₂(v) based, at least in part, on the implementation of the SNN-based graph sampler (i.e., the SNN model 234).

The processor 206 is then configured to pass the different filtered sub-graphs through different graph convolutional network (GCN) layers to obtain a representation h_{(v, k)}. After filtering the sub-graphs to receive the filtered sub-graphs, the processor 206 is configured to aggregate the label-aware sub-graphs using message passing based at least on graph neural network (GNN) layers. In addition, message passing is designed in such a manner to collect all the information from all the neighbors present.

Further, separate GCN layers are utilized for information aggregation for each filtered label-aware neighborhood. This step then results in K embeddings for a node, where K is the number of classes. These K embedding matrices can then be aggregated using different available aggregation functions (such as mean, concat, max, attention, etc.) resulting in a final embedding matrix containing embeddings for all the selected nodes of the base graph 502. With reference to FIG. 5, the value of K is 3 since 3 classes are used and 3 threshold values (ρₖ) are defined to perform the respective under-sampling and over-sampling of nodes of these 3 classes. To that end, as may be understood, the present approach can be configured for different classification tasks for a different number of classes by setting different values of K.

Let h_{v,k}∈R^{d} denote the representation of node v of dimension d using the filtered neighborhood corresponding to class k, where v∈V and k∈{1, 2, . . . , K}. Then,

h_{v,k}=ReLU (W^{(k)}(AGG^{(k)}{hᵤ, u∈N̅ₖ̅(v), v∈V and ∀k∈{1, 2 . . . K}})) Eqn. (7)

Mathematically, the final embedding for the nodes can be calculated using Equation (8) provided below:

hᵥ=AGG (h_{v,0},h_{v,1},h_{v,2}, . . . , h_{v,k})∀k∈{1, 2 . . . K} Eqn. (8)

Where the AGG function used in Equation (8) can be mean, max, concat, and the like. With reference to FIG. 5, different filtered sub-graphs are passed through separate GCN layers. For example, the filtered sub-graph N̅₀̅(v) is passed through a GCN layer 0 (see, 526) to generate an embedding h v ,o (see, 528). Similarly, the filtered sub-graph N̅₁̅(v) is passed through a GCN layer 1 (see, 530) to generate an embedding h_{v, 1} (see, 532). Moreover, the filtered sub-graph N̅₂̅(v) is passed through a GCN layer 2 (see, 534) to generate an embedding h_{v,2} (see, 536). The processor 206 is then configured to apply an aggregate function (see, 538) over the three sets of embeddings (i.e., h_{v,0}, h_{v,1}, and h_{v,2}) to generate a final node embedding h_{y} (see, 540) corresponding to each node in the base graph 502. In some non-limiting examples, the aggregate function may include mean, max, concat, and the like.

The processor 206 is further configured to pass the final node representation through a dense layer (see, 542) to obtain the output label for each node in the base graph 502. Once the final node representation vector is obtained, a multi-layer perceptron (MLP) classifier is trained together with separate graph neural network (GNN) layers to minimize cross-entropy (CE) loss for the downstream prediction task of classifying into fraudulent or non-fraudulent categories (see, 544). Mathematically, the CE loss may be calculated using Equation (9) provided below:

L=Σ_{v∈V}^{∞}yᵥlogpᵥ+(1−yᵥ)log(1−pᵥ) Eqn. (9)

Where pᵥ=MLP(hᵥ) Eqn. (10)

In one example, the implementation of the GNN model 232 and the SNN model 234 is proposed in detail in Algorithm 1.

```
Algorithm 1:
Input: G = (V, E, X, Y)
Initialization: Eₖ (Edge index for a class k) as the empty index
set
Split: Class-wise segregation of edges
for (v, u) ∈ E do
  if Yᵤ = k then
    Eₖ = Eₖ ∪ (u, v)
  end if
end for
Filter:
for edge (v, u) ∈ Eₖ do
  for u ∈ Eₖ (v) do
    dᵤ, d_{y} = Siamese (Xᵤ, Xᵥ)
    S (u, v) = e^{-∥d}^{ᵤ}^{-d}^{ᵥ}^{∥}^{₂}^{²}
    $Normalized Score : {S}_{n} ( u , v ) = \frac{S ( u , v )}{\sum S ( u , v )} where u ∈ {N}_{k} ( v )$
    if Sₙ (v, u) > ρₖ then
      E′ₖ = E′ₖ ∪ (v, u)
    end if
  end for
end for
Aggregate:
for edge (v, u) ∈ E′ₖ do
  for v ∈ V do
    h_{v,k} = calculate using Equation (7)
    hᵥ = calculate using Equation (8)
  end for
end for
Multi-Layer Perceptron (MLP) Classifier: Training using Binary Cross-
Entropy Loss as per Equation (9)
\hat{p} = MLP (hᵥ)
Output: (\hat{p} for category {fraud, non-fraud})
```

From the above-mentioned algorithm 1, it can be observed that given a graph G and the training node set V, initially, the processor 206 is configured to identify K different edge sets Eₖ corresponding to each of the K classes in the split step. Then, the processor 206 is configured to find filtered edge sets E′ₖ in the filter step. Further, the processor 206 is configured to aggregate from K different neighborhoods.

### Performance Metrics

In a particular experiment, the GNN model 232 described herein was implemented on a real-world financial dataset that maps bitcoin transactions to real entities belonging to licit categories (such as exchanges, wallet providers, miners, etc.) versus illicit categories (such as scams, malware, ransomware, etc.). The classification task aimed to classify the illicit and licit nodes in the base graph. In other words, the aim was to identify suspicious entities which are involved in conducting illicit transactions on financial service platforms.

In this experiment setting, an Elliptic dataset is used to perform the classification task. It is noted that the Elliptic dataset includes an anonymized data set which is a transaction graph (i.e., base graph) collected from a Bitcoin blockchain. In addition, a node in the transaction graph represents a transaction and an edge represents the flow of Bitcoins between one transaction and the other. Further, each transaction node has 166 features associated with it, where 94 features information about the transaction itself (i.e., local features), and the remaining 72 features are formed using the information of one-hop backward/forward pass from the transaction (i.e., aggregate features).

There is a total of 49 different timesteps ranging from 1 to 49. Furthermore, any two timesteps are separated by two weeks and each timestep records transactions of less than 3 hours. Apart from the timestep, all the other features are anonymized. Moreover, each node has been labeled as being created by a licit or illicit entity. The transaction graph is composed of 203,769 nodes and 234,355 edges. Out of which, only 2% (i.e., 4545) of the nodes belong to the illicit class whereas 20% (i.e., 42,019) of the nodes are labeled as licit. The remaining transactions are left as unknown or unlabeled. The unlabeled nodes are considered a third class of nodes, called the Unknown class.

The performance of the GNN model 232 is then compared with several other known in the art, i.e., conventional graph neural network (GNN) based models. For example, the proposed GNN model 232 is implemented in a graph convolution network (GCN) model, graph attention network (GAT) model, GraphSAGE model, and a GraphConsis model.

As may be understood, the GCN model is a graph neural network architecture that is accomplished by first-order estimation of spectral graph convolution in the form of a message passing network where the information is propagated along the neighboring nodes within the graph. The GAT model operates on graph structured data, leveraging masked self-attention layers for neighborhood aggregation. The GraphSAGE model is an inductive GNN model that utilizes node feature information to generate embeddings for nodes in the graph. The GraphConsis model architecture caters to tackling context inconsistency, feature inconsistency, and relation inconsistency problems in a heterogenous graph neural network.

The experiments investigate the performance of baseline models with their modified versions equipped with the proposed GNN model 232 in class imbalanced graph-based fraud detection tasks. The experimental results show that the GCN model, GAT model, and GraphSAGE model equipped with the GNN model 232 outperform the baselines, with 3.7% and 16.66% improvement in terms of area under curve (AUC) and F1-Macro respectively in the case of GCN, 9.29% and 14.86% improvement in terms of AUC and F1-Macro respectively in the case of GAT model, and 7.05% and 18.66% improvement in terms of AUC and F1-Macro respectively in the case of GraphSAGE model. The precision, recall, and F1 scores for the illicit class are also higher in models equipped with the proposed GNN model 232 than in their baseline versions.

Table 1 illustrates performance metrics of the GNN model 232 on an elliptic dataset (e.g., bitcoin dataset) for fraud detection. The results are recorded in Table 1, where F refers to the neighborhood filter module, S refers to the sampler module, and split-filter-aggregate (SFA) refers to the proposed GNN model 232.

TABLE 1
Performance metrics of GNN model on an elliptic dataset
(bitcoin dataset) for fraud detection

| Model | | Illicit | | | |
|---|---|---|---|---|---|
| Version | AUC | Precision | Recall | F1-Score | Macro-F1 |
| GraphConsis | 0.616 | 0.22 | 0.31 | 0.26 | 0.60 |
| Base-GCN | 0.86 | 0.49 | 0.27 | 0.35 | 0.66 |
| GCN^{F} | 0.85 | 0.40 | 0.26 | 0.31 | 0.64 |
| GCN^{S} | 0.907 | 0.56 | 0.65 | 0.60 | 0.79 |
| SFA-GCN | 0.8919 | 0.52 | 0.63 | 0.57 | 0.77 |
| Base-GAT | 0.8733 | 0.49 | 0.53 | 0.51 | 0.74 |
| GAT^{F} | 0.78626 | 0.21 | 0.59 | 0.31 | 0.6 |
| GAT^{S} | 0.941 | 0.63 | 0.72 | 0.67 | 0.82 |
| SFA-GAT | 0.9545 | 0.71 | 0.72 | 0.72 | 0.85 |
| Base-SAGE | 0.89489 | 0.49 | 0.57 | 0.53 | 0.75 |
| SAGE^{F} | 0.87535 | 0.40 | 0.62 | 0.48 | 0.72 |
| SAGE^{C} | 0.9282 | 0.79 | 0.68 | 0.73 | 0.86 |
| SFA-SAGE | 0.958 | 0.92 | 0.71 | 0.8 | 0.89 |

In another experiment, performance metrics of the proposed GNN model 232 are compared with other known in the art or conventional models. It is shown in Table 2 that the GNN model 232 is superior to other known in the art models. In Table 2, the performance metrics of the GNN model are compared with other non-graph models on the Elliptic dataset. Based on the results depicted in Table 2, the proposed GNN model 232 easily outperforms other models including, for example, Logistic regression models, MLP based models, and even tree-based models.

However, it is noted that the power of GNNs relies on their capability of capturing the graph structure simultaneously with the node features. Rather than only considering the instances (i.e., nodes with their features) independently, GNNs also leverage the relationships and structure between them. In particular, GNNs generally follow a message-passing mechanism, where nodes aggregate the information from their neighbors in each layer. By stacking various GNN layers, information can be proliferated further through the graph structure and nodes can be embedded into low-dimensional representations. Such neighborhood structure-based aggregation is not possible in the case of tree-based methods and thus, the GCN based models have their own significance in the domain of fraud detection.

TABLE 2
Performance metrics of the GNN model on illicit classes
using non-graph based approaches

| Method | Precision | Recall | F1-Score |
|---|---|---|---|
| Logistic Regr^{AF} | 0.404 | 0.593 | 0.481 |
| Logistic Regr^{AF+NE} | 0.537 | 0.528 | 0.533 |
| Logistic Regr^{LF} | 0.348 | 0.668 | 0.457 |
| Logistic Regr^{LF+NE} | 0.518 | 0.571 | 0.543 |
| Random Forest^{AF} | 0.956 | 0.670 | 0.778 |
| Random Forest^{AF+NE} | 0.971 | 0.675 | 0.796 |
| Random Forest^{LF} | 0.803 | 0.611 | 0.694 |
| Random Forest^{LF+NE} | 0.878 | 0.668 | 0.759 |
| MLP^{AF} | 0.694 | 0.617 | 0.653 |
| MLP^{AF+NE} | 0.780 | 0.617 | 0.689 |
| MLP^{LF} | 0.637 | 0.662 | 0.649 |
| MLP^{LF+NE} | 0.6819 | 0.5782 | 0.6258 |
| SFA-SAGE | 0.92 | 0.71 | 0.80 |

In Table 2, AF refers to all features, LF refers to local features (i.e., 94 features), and NE refers to node embeddings computed by GCN.

### Implementation Details

The proposed GNN model 232 is implemented in Pytorch 1.10.2 environment with Python 3.7 and each of the above-mentioned experiments are implemented on Amazon SageMaker Studio Lab with 4 cores and 16GB memory. GCN, Graph-SAGE, and GAT are carried out based on a deep graph library (DGL). GraphConsis is implemented using their provided source code. It is noted that the same should not be considered as a limitation of the present disclosure, rather the same only reflects a non-limiting implementation of the various embodiments of the present disclosure. To that end, other suitable techniques and technologies may also be used to implement the proposed GNN model 232 without departing from the scope of the present disclosure.

In the case of classification on an imbalanced dataset, the evaluation metric should not be biased toward any particular class. Therefore, performance metrics such as AUC and F1-macro are used for model comparison. Generally, AUC may refer to Area under ROC curve, and can be mathematically defined as:

$$AUC = \frac{{\sum }_{u ∈ U} + {rank}_{u} - \frac{\vert {U}^{+} \vert X ( \vert {U}^{+} \vert + 1 )}{2}}{\vert {U}^{+} \vert X \vert {U}^{-} \vert} \qquad Eqn . ( 11 )$$

Where U⁺ and U³¹ denote the minority and majority class set in the testing set, respectively. Also, rankᵤ indicates the rank of the node u via the score of prediction. Further, macro-averaged F₁-Score is the unweighted mean of the F₁-scores of each class. Therefore, higher values of both AUC and F₁-macro score indicates higher performance of the model.

In one implementation, the processor 206 is configured to train the SNN model 234 based on Algorithm 2.

Algorithm 2:

```
For each edge: e (u, v)
  If label (u) = label (v), label it as positive pair
  If label (u) != label (v), label it as negative pair
  Train Siamese network using contrastive loss using node features
Input: node features of (u, v)
Output: d1, d2
```

In one implementation, the processor 206 is configured to perform label-aware neighborhood splitting for each node in the base graph based on Algorithm 3.

Algorithm 3:

```
Let k: number of classes
Let E: Edge index of full graph
Let Eₖ: Edge index of class k, initialize as empty edge index
For each node, u:
  For each v in N (u):
    if label (v) = k: Eₖ = Eₖ ∪ (u, v)
Input: Edge Index E of full graph
Output: {E₀, E₁, E₂.... Eₖ}
```

In one implementation, the processor 206 is configured to implement the Siamese neural network (i.e., the SNN model 234) using contrastive loss based on Algorithm 4.

Algorithm 4:

```
For each edge index Eₖ:
  For each node u in Eₖ:
    For each v in N (u):
      d1, d2 = Siamese (u, v)
      s (u, v) = exp (−(d1−d2) \hat{ } 2)
    normalized score (u, v) = s (u, v)/ sum of s (u, v) where v in N (u)
if normalized score > epsk: E′ₖ = E′ₖ ∪ (u, v)
Input: Eₖ
Output: E′ₖ
```

In one implementation, the processor 206 is configured to implement the MLP based classifier for fraud/ non-fraud classification based on Algorithm 5.

Algorithm 5:

```
Let Xu: Node u features
Let AGG: Aggregator function such as mean/max/concat/attention
For each edge index E′ₖ:
  For each node u in E′ₖ:
    hku = GCN (Xu, E′ₖ)
hu = AGG (h1u, h2u.... hku)
prediction = sigmoid (Wx [RELU (hu)] + b)
Train classifier using binary cross-entropy (BCE loss) (prediction,
true label)
```

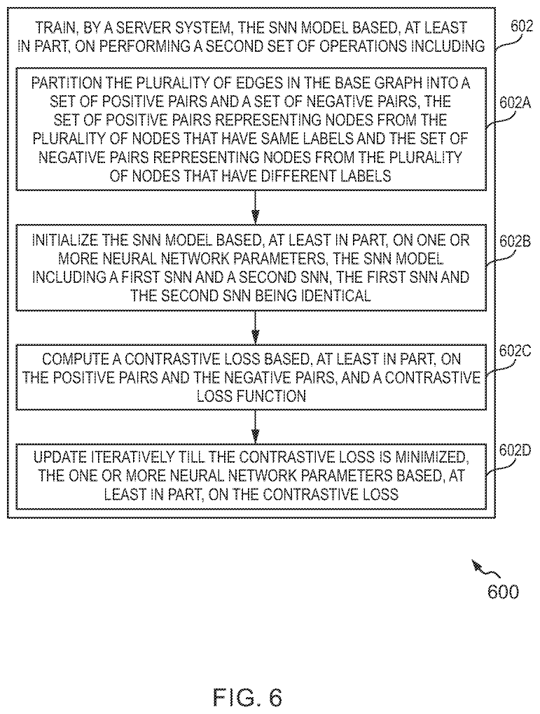

FIG. 6 is a flow chart 600 of training of Siamese neural network (SNN) model 234, in accordance with an embodiment of the present disclosure. At the onset, the server system 200 accesses historical electronic transaction data of electronic transactions performed between the plurality of entities 104a-104c. The electronic transactions may be performed between the plurality of entities 104a-104c in a time segment. In some non-limiting examples, the time segment may correspond to 1 month, 3 months, 6 months, 1 year, 2 years, and the like. In addition, the electronic transactions may have a label associated with them i.e., each electronic transaction can be labeled as either fraudulent or non-fraudulent. Similarly, each entity of the plurality of entities 104a-104c may also have a label associated with them e.g., each entity of the plurality of entities 104a-104c may be labeled as either fraudulent or non-fraudulent. The server system 200 accesses the historical electronic transaction data from the transaction database 112.

Then, the server system 200 generates a labeled homogeneous graph based, at least in part, on the historical electronic transaction data. In the labeled homogeneous graph, the plurality of entities 104a-104c may be represented as a plurality of nodes. In addition, the edges between the plurality of nodes may represent an association or relationship between the plurality of entities 104a-104c.

For example, the plurality of nodes may represent payment instruments (e.g., payment accounts, payment wallets, payment cards, etc.) and can be represented as the plurality of nodes. In addition, the edges between the plurality of nodes may represent electronic transactions performed between the plurality of entities 104a-104c. In addition, the edges can be directed (i.e., showing the flow of electronic transactions) or undirected. In addition, each node of the plurality of nodes has a label associated with it i.e., each node is labeled as either fraudulent or non-fraudulent.

To that end, the sequence of operations of the flow chart 600 may not be necessarily executed in the same order as they are presented. Further, one or more operations may be grouped and performed in the form of a single step, or one operation may have several sub-steps that may be performed in parallel or in a sequential manner.

At 602, the server system 200 trains the SNN model 234 based, at least in part, on performing a second set of operations. The second set of operations may include operations 602A-602D.

At 602A, the server system 200 partitions the plurality of edges in the base graph into a set of positive pairs and a set of negative pairs. Herein, the set of positive pairs represents nodes from the plurality of nodes that have the same labels. In other words, the “positive pairs” herein represent two nodes if both nodes have the same label (e.g., if both nodes are fraudulent or if both nodes are non-fraudulent). Further, the set of negative pairs representing nodes from the plurality of nodes that have different labels. In other words, the “negative pairs” herein represents two nodes if both nodes have the different label (e.g., one node is fraudulent and the other one is non-fraudulent).

At 602B, the server system 200 initializes the SNN model 234 based, at least in part, on one or more neural network parameters (e.g., weights, biases, etc.) of the SNN model 234. Herein, the SNN model 234 includes a first SNN and a second SNN such that the first SNN and the second SNN are identical to each other.

At 602C, the server system 200 computes a contrastive loss based, at least in part, on the set of positive pairs, the set of negative pairs, and a contrastive loss function. In a non-limiting example, the contrastive loss function is also called a Siamese loss function. In one implementation, the SNN model 234 is configured to learn embeddings in which two similar nodes have a low Euclidean distance and two dissimilar nodes have a large Euclidean distance.

At 602D, the server system 200 updates the one or more neural network parameters based, at least in part, on the contrastive loss. This step may be repeated iteratively till the contrastive loss is minimized.

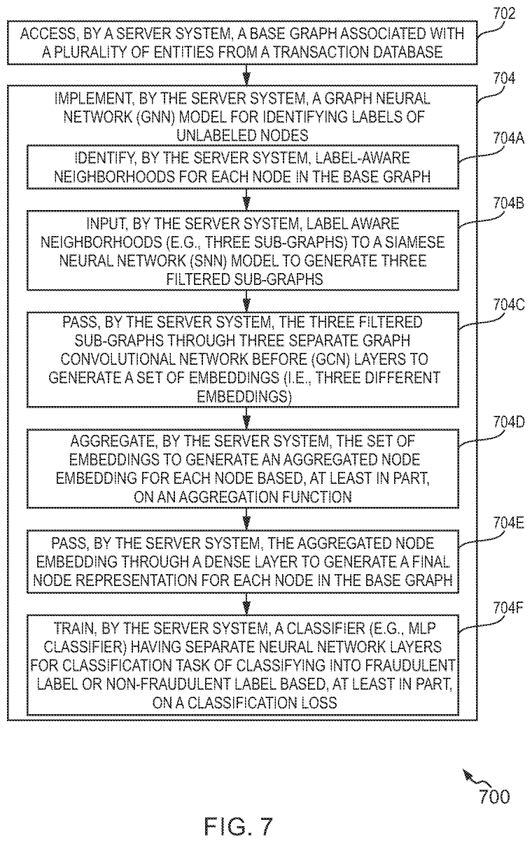

FIG. 7 is a flow chart 700 of the implementation of the graph neural network (GNN) model 232, in accordance with an embodiment of the present disclosure. The sequence of operations of the flow chart 700 may not be necessarily executed in the same order as they are presented. Further, one or more operations may be grouped and performed in the form of a single step, or one operation may have several sub-steps that may be performed in parallel or in a sequential manner.

At 702, the server system 200 accesses a base graph associated with the plurality of entities 104a-104c from the transaction database 112. In the base graph, each entity of the plurality of entities 104a-104c is represented as a node. In addition, the base graph includes edges (e.g., directed, or undirected) between the nodes that represent an association or relationship between the nodes. In an example, the edges may represent electronic transactions performed between the plurality of entities 104a-104c. The base graph may include labeled and unlabeled nodes. The “labeled nodes” herein refer to those nodes that have a label associated with them (e.g., fraudulent, or non-fraudulent). The “unlabeled nodes” herein refer to those nodes that do not have a label associated with them. For the sake of simplicity, let us consider that the base graph includes a single central node ‘n’ and neighboring nodes connected with the central node ‘n’. In an example, the neighboring nodes can be either labeled or unlabeled.

At 704, the server system 200 implements or runs the GNN model 232 for identifying the labels of the unlabeled nodes. To identify the labels for the unlabeled nodes, the server system 200 is configured to execute a plurality of operations for each node (here, central node ‘n’) in the base graph. The plurality of operations is explained in detail below in steps 704a-704f.

At 704A, the server system 200 is configured to identify label-aware neighborhoods for each node in the base graph. More specifically, the server system 200 is configured to split the base graph into three different sub-graphs for each node—a first sub-graph including only those nodes that are labeled as fraudulent, a second sub-graph including only those nodes that are labeled as non-fraudulent, and a third sub-graph including the remaining unlabeled nodes.

At 704B, the server system 200 inputs the three sub-graphs to the SNN model 234 to generate three filtered sub-graphs. In one implementation, the SNN model 234 includes three different Siamese neural networks with different pre-defined threshold values. The SNN model 234 is configured to generate three filtered sub-graphs corresponding to the three sub-graphs based on the pre-defined threshold values. The filtering is performed to under-sample the majority class and over-sample the minority class. In other words, the SNN model 234 is configured to under-sample the minority class and over-sample the minority class.

At 704C, the server system 200 passes the three filtered sub-graphs through three separate GCN layers to generate a set of embeddings (i.e., three different embeddings). The three different embeddings are generated corresponding to the three different filtered sub-graphs.

At 704D, the server system 200 aggregates the set of embeddings to generate an aggregated node embedding for each node (here, central node) based, at least in part, on an aggregation function. In some non-limiting examples, the aggregation function may include mean, max, concat, attention, and the like.

At 704E, the server system 200 passes the aggregated node embedding through a dense layer to generate a final node representation for each node in the base graph.

At 704F, the server system 200 trains a classifier (e.g., MLP classifier) having separate neural network layers for the classification task of classifying into fraudulent label or non-fraudulent label based, at least in part, on a classification loss. In one non-limiting example, the classification loss is a binary cross-entropy (BCE) loss.

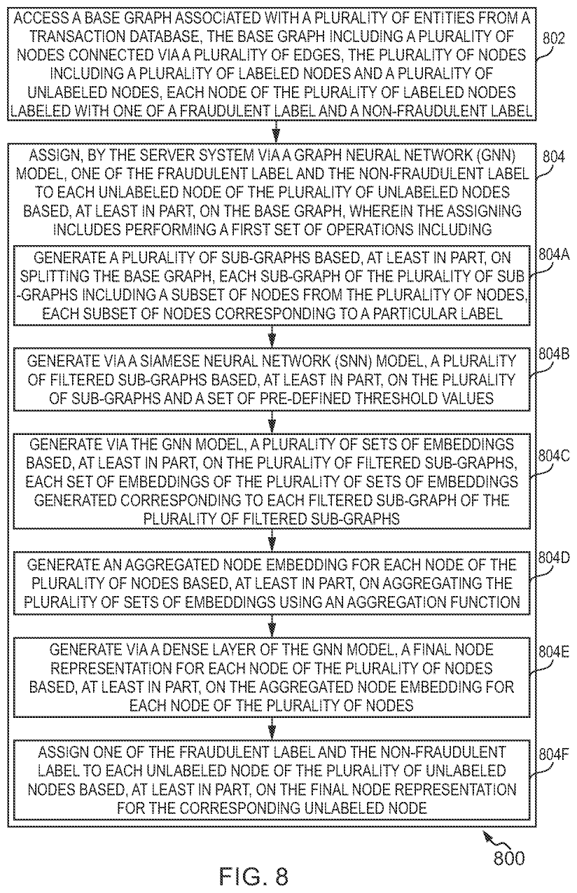

FIG. 8 illustrates a process flow diagram depicting a method 800 for detecting fraudulent transactions in electronic payment transactions, in accordance with an embodiment of the present disclosure. The method 800 depicted in the flow diagram may be executed by, for example, the server system 200. The sequence of operations of the method 800 may not be necessarily executed in the same order as they are presented. Further, one or more operations may be grouped and performed in the form of a single step, or one operation may have several sub-steps that may be performed in parallel or in a sequential manner. Operations of the method 800, and combinations of operations in the method 800 may be implemented by, for example, hardware, firmware, a processor, circuitry, and/or a different device associated with the execution of software that includes one or more computer program instructions. The plurality of operations is depicted in the process flow of the method 800. The process flow starts at operation 802.

At 802, the method 800 includes accessing, by a server system such as server system 200, a base graph associated with a plurality of entities from a transaction database. Herein, the base graph includes a plurality of nodes connected via a plurality of edges. Further, the plurality of nodes includes a plurality of labeled nodes and a plurality of unlabeled nodes. Herein, each node of the plurality of labeled nodes is labeled with one of a fraudulent label and a non-fraudulent label.

At 804, the method 800 includes assigning, by the server system 200 via a Graph Neural Network (GNN) model such as GNN model 232, one of the fraudulent label and the non-fraudulent label to each unlabeled node of the plurality of unlabeled nodes based, at least in part, on the base graph. It is noted that the assigning process includes performing a first set of operations including operations 802A-802F.

At 804A, the method 800 includes generating a plurality of sub-graphs based, at least in part, on splitting the base graph. In particular, each sub-graph of the plurality of sub-graphs includes a subset of nodes from the plurality of nodes such that each subset of nodes corresponds to a particular label.

At 804B, the method 800 includes generating via a Siamese Neural Network (SNN) model such as SNN model 234, a plurality of filtered sub-graphs based, at least in part, on the plurality of sub-graphs and a set of pre-defined threshold values. It is noted that the set of thresholds may be determined based, at least in part, on various model fine-tuning and experimental results from various experiments performed based on the various embodiments described herein. In other words, the set of thresholds may defined as per the experimental results on testing datasets, hyperparameter tuning and as per the domain of application.

At 804C, the method 800 includes generating via the GNN model 232, a plurality of sets of embeddings based, at least in part, on the plurality of filtered sub-graphs. Herein, each set of embeddings of the plurality of sets of embeddings is generated corresponding to each filtered sub-graph of the plurality of filtered sub-graphs.

At 804D, the method 800 includes generating an aggregated node embedding for each node of the plurality of nodes based, at least in part, on aggregating the plurality of sets of embeddings using an aggregation function.

At 804E, the method 800 includes generating via a dense layer of the GNN model 232, a final node representation for each node of the plurality of nodes based, at least in part, on the aggregated node embedding for each node of the plurality of nodes.

At 804F, the method 800 includes assigning one of the fraudulent label and the non-fraudulent label to each unlabeled node of the plurality of unlabeled nodes based, at least in part, on the final node representation for the corresponding unlabeled node.

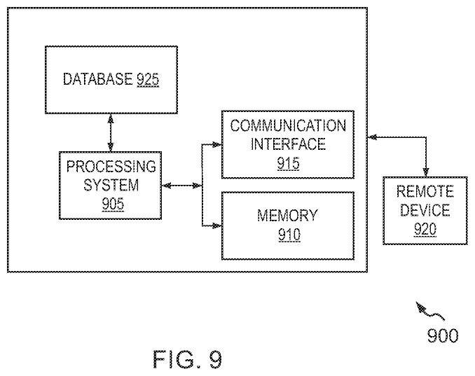

FIG. 9 is a simplified block diagram of a payment server 900, in accordance with an embodiment of the present disclosure. The payment server 900 is an example of the payment server 116 of FIG. 1. The payment server 900 and the server system 200 may use the payment network 114 as a payment interchange network. Examples of payment interchange networks include, but are not limited to, Mastercard® payment system interchange network. In one example, the server system 200 is an example of the payment server 900.

The payment server 900 includes a processing system 905 configured to extract programming instructions from a memory 910 to provide various features of the present disclosure. The components of the payment server 900 provided herein may not be exhaustive and that the payment server 900 may include more or fewer components than that depicted in

FIG. 9. Further, two or more components may be embodied in one single component, and/or one component may be configured using multiple sub-components to achieve the desired functionalities. Some components of the payment server 900 may be configured using hardware elements, software elements, firmware elements, and/or a combination thereof.

Via a communication interface 915, the processing system 905 receives a request from a remote device 920, such as an issuer server or acquirer server. The request may be a request for conducting the payment transaction. The communication may be achieved through API calls, without loss of generality. The payment server 900 includes a database 925. The database 925 also includes transaction processing data such as issuer ID, country code, acquirer ID, merchant identifier (MID), among others.

When the payment server 900 receives a payment transaction request from the acquirer server (not shown in figures) or a payment terminal (e.g., point of sale (POS) device, etc.), the payment server 900 may route the payment transaction request to an issuer server (not shown in figures). The database 925 is configured to store transaction identifiers for identifying transaction details such as, transaction amount, payment card details, acquirer account information, transaction records, merchant account information, and the like.

In one example, the acquirer server is configured to send an authorization request message to the payment server 900. The authorization request message includes, but is not limited to, the payment transaction request.

The processing system 905 further sends the payment transaction request to the issuer server for facilitating the payment transactions from the remote device 920. The processing system 905 is further configured to notify the remote device 920 of the transaction status in form of an authorization response message via the communication interface 915. The authorization response message includes, but is not limited to, a payment transaction response received from the issuer server. Alternatively, in one embodiment, the processing system 905 is configured to send an authorization response message for declining the payment transaction request, via the communication interface 915, to the acquirer server.

The disclosed methods with reference to FIGS. 1 to 9, or one or more operations of the methods 600, 700, and 800 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, netbook, Web book, tablet computing device, smartphone, or other mobile computing devices). Such software may be executed, for example, on a single local computer or in a network environment (e.g., via the Internet, a wide-area network, a local-area network, a remote web-based server, a client-server network (such as a cloud computing network), or other such networks) using one or more network computers. Additionally, any of the intermediate or final data created and used during the implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means includes, for example, the Internet, the World Wide Web, an intranet, software applications, cable (including fiber optic cable), magnetic communications, electromagnetic communications (including RF, microwave, and infrared communications), electronic communications, or other such communication means.

Although the disclosure has been described with reference to specific exemplary embodiments, it is noted that various modifications and changes may be made to these embodiments without departing from the broad scope of the disclosure. For example, the various operations, blocks, etc. described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application-specific integrated circuit (ASIC) circuitry and/or in Digital Signal Processor (DSP) circuitry).

Particularly, the server system 200 (e.g., the server system 102) and its various components such as the computer system 202 and the database 204 may be enabled using software and/or using transistors, logic gates, and electrical circuits (for example, integrated circuit circuitry such as ASIC circuitry). Various embodiments of the disclosure may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different than those which are disclosed. Therefore, although the invention has been described based upon these exemplary embodiments, it is noted that certain modifications, variations, and alternative constructions may be apparent and well within the scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method, comprising:
accessing, by a server system, a base graph associated with a plurality of entities from a transaction database, the base graph comprising a plurality of nodes connected via a plurality of edges, the plurality of nodes comprising a plurality of labeled nodes, and a plurality of unlabeled nodes, each node of the plurality of labeled nodes labeled with one of a fraudulent label and a non-fraudulent label; and
assigning, by the server system via a Graph Neural Network (GNN) model, one of the fraudulent label and the non-fraudulent label to each unlabeled node of the plurality of unlabeled nodes based, at least in part, on the base graph, wherein the assigning comprises performing a first set of operations comprising:
generating a plurality of sub-graphs based, at least in part, on splitting the base graph, each sub-graph of the plurality of sub-graphs comprising a subset of nodes from the plurality of nodes, each subset of nodes corresponding to a particular label,
generating via a Siamese Neural Network (SNN) model, a plurality of filtered sub-graphs based, at least in part, on the plurality of sub-graphs and a set of pre-defined threshold values,
generating via the GNN model, a plurality of sets of embeddings based, at least in part, on the plurality of filtered sub-graphs, each set of embeddings of the plurality of sets of embeddings generated corresponding to each filtered sub-graph of the plurality of filtered sub-graphs,
generating an aggregated node embedding for each node of the plurality of nodes based, at least in part, on aggregating the plurality of sets of embeddings using an aggregation function,
generating via a dense layer of the GNN model, a final node representation for each node of the plurality of nodes based, at least in part, on the aggregated node embedding for each node of the plurality of nodes, and
assigning one of the fraudulent label and the non-fraudulent label to each unlabeled node of the plurality of unlabeled nodes based, at least in part, on the final node representation for the corresponding unlabeled node.

2. The computer-implemented method as claimed in claim 1, further comprising:
accessing, by the server system, historical payment transaction data from the transaction database associated with the server system, the historical payment transaction data comprising labeled and unlabeled electronic transaction data associated with the plurality of entities;
extracting, by the server system, a plurality of graph features based, at least in part, on the historical payment transaction data; and
generating, by the server system, the base graph based, at least in part, on the plurality of graph features, the base graph being a homogeneous graph.

3. The computer-implemented method as claimed in claim 1, wherein the plurality of sub-graphs further comprises a first sub-graph, a second sub-graph, and a third sub-graph, the first sub-graph comprising the subset of nodes from the plurality of labeled nodes labeled with the fraudulent label, the second sub-graph comprising the subset of nodes from the plurality of labeled nodes labeled with the non-fraudulent label, and the third sub-graph comprising the subset of nodes from the plurality of unlabeled nodes.

4. The computer-implemented method as claimed in claim 1, further comprising:
training, by the server system, the SNN model based, at least in part, on performing a second set of operations comprising:
partitioning the plurality of edges in the base graph into a set of positive pairs and a set of negative pairs, the set of positive pairs representing nodes from the plurality of nodes that have same labels and the set of negative pairs representing nodes from the plurality of nodes that have different labels;
initializing the SNN model based, at least in part, on one or more neural network parameters, the SNN model comprising a first SNN and a second SNN, the first SNN and the second SNN being identical;
computing a contrastive loss based, at least in part, on the set of positive pairs, the set of negative pairs, and a contrastive loss function; and
updating iteratively till the contrastive loss is minimized, the one or more neural network parameters based, at least in part, on the contrastive loss.

5. The computer-implemented method as claimed in claim 1, wherein generating the plurality of filtered sub-graphs, further comprises:
computing, by the server system via a first SNN of the SNN model, a first output score corresponding to a first node in a corresponding pair connected via a particular edge with a second node for each node in the each sub-graph of the plurality of sub-graphs;
computing, by the server system via a second SNN of the SNN model, a second output score corresponding to the second node in the corresponding pair connected via the particular edge with the first node for each node in the each sub-graph of the plurality of sub-graphs;
computing, by the server system, a euclidean distance based, at least in part, on the first output score and the second output score; and
filtering, by the server system, each sub-graph of the plurality of sub-graphs to generate the plurality of filtered sub-graphs based, at least in part, on the euclidean distance and a pre-defined threshold value corresponding to the each sub-graph from the set of pre-defined threshold values.

6. The computer-implemented method as claimed in claim 1, wherein the plurality of sets of embeddings comprises a first set of embeddings corresponding to a first filtered sub-graph, a second set of embeddings corresponding to a second filtered sub-graph, and a third set of embeddings corresponding to a third filtered sub-graph.

7. The computer-implemented method as claimed in claim 1, wherein assigning one of the fraudulent label and the non-fraudulent label to each unlabeled node of the plurality of unlabeled nodes further comprises:
computing, by the server system, a final score for each unlabeled node of the plurality of unlabeled nodes based, at least in part, on applying a sigmoid function to the final node representation for the corresponding unlabeled node; and
performing, by the server system, at least one of:
assigning the fraudulent label to the corresponding unlabeled node based, at least in part, on determining that the computed final score for the corresponding unlabeled node is at least equal to a pre-defined threshold score, and
assigning the non-fraudulent label to the corresponding unlabeled node based, at least in part, on determining that the computed final score for the corresponding unlabeled node is lesser than the pre-defined threshold score.

8. The computer-implemented method as claimed in claim 1, wherein assigning one of the fraudulent label and the non-fraudulent label to each unlabeled node of the plurality of unlabeled nodes further comprises:
classifying, by the server system via a classifier, each unlabeled node of the plurality of unlabeled nodes as one of the fraudulent node and the non-fraudulent node based, at least in part, on a classification loss and the final node representation for the corresponding unlabeled node; and
assigning, by the server system, one of the fraudulent label and the non-fraudulent label to each unlabeled node of the plurality of unlabeled nodes based, at least in part, on the classifying step.

9. The computer-implemented method as claimed in claim 1, wherein the server system is a payment server associated with a payment network.

10. The computer-implemented method as claimed in claim 1, wherein the GNN model is a Split-Filter-Aggregate Graph Neural Network (SFA-GNN) based model.

11. A server system, comprising:
a memory configured to store instructions;
a communication interface; and
a processor in communication with the memory and the communication interface, the processor configured to execute the instructions stored in the memory and thereby cause the server system to perform at least in part to:
access a base graph associated with a plurality of entities from a transaction database, the base graph comprising a plurality of nodes connected via a plurality of edges, the plurality of nodes comprising a plurality of labeled nodes and a plurality of unlabeled nodes, each node of the plurality of labeled nodes labeled with one of a fraudulent label and a non-fraudulent label; and
assign via a Graph Neural Network (GNN) model, one of the fraudulent label and the non-fraudulent label to each unlabeled node of the plurality of unlabeled nodes based, at least in part, on the base graph, wherein the assigning comprises performing a first set of operations comprising:
generating a plurality of sub-graphs based, at least in part, on splitting the base graph, each sub-graph of the plurality of sub-graphs comprising a subset of nodes from the plurality of nodes, each subset of nodes corresponding to a particular label,
generating via a Siamese Neural Network (SNN) model, a plurality of filtered sub-graphs based, at least in part, on the plurality of sub-graphs and a set of pre-defined threshold values,
generating via the GNN model, a plurality of sets of embeddings based, at least in part, on the plurality of filtered sub-graphs, each set of embeddings of the plurality of sets of embeddings generated corresponding to each filtered sub-graph of the plurality of filtered sub-graphs,
generating an aggregated node embedding for each node of the plurality of nodes based, at least in part, on aggregating the plurality of sets of embeddings using an aggregation function,
generating via a dense layer of the GNN model, a final node representation for each node of the plurality of nodes based, at least in part, on the aggregated node embedding for each node of the plurality of nodes, and
assigning one of the fraudulent label and the non-fraudulent label to each unlabeled node of the plurality of unlabeled nodes based, at least in part, on the final node representation for the corresponding unlabeled node.

12. The server system as claimed in claim 11, wherein the server system is further caused, at least in part, to:
access historical payment transaction data from the transaction database, the historical payment transaction data comprising labeled and unlabeled electronic transaction data associated with the plurality of entities;
extract a plurality of graph features based, at least in part, on the historical payment transaction data; and
generate the base graph based, at least in part, on the plurality of graph features, the base graph being a homogeneous graph.

13. The server system as claimed in claim 11, wherein the plurality of sub-graphs further comprises a first sub-graph, a second sub-graph, and a third sub-graph, the first sub-graph comprising the subset of nodes from the plurality of labeled nodes labeled with the fraudulent label, the second sub-graph comprising the subset of nodes from the plurality of labeled nodes labeled with the non-fraudulent label, and the third sub-graph comprising the subset of nodes from the plurality of unlabeled nodes.

14. The server system as claimed in claim 11, wherein the server system is further caused, at least in part, to:
train the SNN model based, at least in part, on performing a second set of operations comprising:
partitioning the plurality of edges in the base graph into a set of positive pairs and a set of negative pairs, the set of positive pairs representing nodes from the plurality of nodes that have same labels and the set of negative pairs representing nodes from the plurality of nodes that have different labels;
initializing the SNN model based, at least in part, on one or more neural network parameters, the SNN model comprising a first SNN and a second SNN, the first SNN and the second SNN being identical;
computing a contrastive loss based, at least in part, on the set of positive pairs and the set of negative pairs, a contrastive loss function; and
updating iteratively till the contrastive loss is minimized, the one or more neural network parameters based, at least in part, on the contrastive loss.

15. The server system as claimed in claim 11, wherein for generating the plurality of filtered sub-graphs, the server system is further caused, at least in part, to:
compute via a first SNN of the SNN model, a first output score corresponding to a first node in a corresponding pair connected via a particular edge with a second node for each node in the each sub-graph of the plurality of sub-graphs;
compute via a second SNN of the SNN model, a second output score corresponding to the second node in the corresponding pair connected via the particular edge with the first node for each node in the each sub-graph of the plurality of sub-graphs;
compute a euclidean distance based, at least in part, on the first output score and the second output score; and
filter each sub-graph of the plurality of sub-graphs to generate the plurality of filtered sub-graphs based, at least in part, on the euclidean distance and a pre-defined threshold value corresponding to the each sub-graph from the set of pre-defined threshold values.

16. The server system as claimed in claim 11, wherein the plurality of sets of embeddings comprises a first set of embeddings corresponding to a first filtered sub-graph, a second set of embeddings corresponding to a second filtered sub-graph, and a third set of embeddings corresponding to a third filtered sub-graph.

17. The server system as claimed in claim 11, wherein for assigning one of the fraudulent label and the non-fraudulent label to each unlabeled node of the plurality of unlabeled nodes, the server system is further caused, at least in part, to:
compute a final score for each unlabeled node of the plurality of unlabeled nodes based, at least in part, on applying a sigmoid function to the final node representation for the corresponding unlabeled node; and
perform at least one of:
assigning the fraudulent label to the corresponding unlabeled node based, at least in part, on determining that the computed final score for the corresponding unlabeled node is at least equal to a pre-defined threshold score, and
assigning the non-fraudulent label to the corresponding unlabeled node based, at least in part, on determining that the computed final score for the corresponding unlabeled node is lesser than the pre-defined threshold score.

18. The server system as claimed in claim 11, wherein for assigning one of the fraudulent label and the non-fraudulent label to each unlabeled node of the plurality of unlabeled nodes, the server system is further caused, at least in part, to:
classify via a classifier, each unlabeled node of the plurality of unlabeled nodes as one of a fraudulent node and a non-fraudulent node based, at least in part, on a classification loss and the final node representation for the corresponding unlabeled node; and
assign one of the fraudulent label and the non-fraudulent label to each unlabeled node of the plurality of unlabeled nodes based, at least in part, on the classifying step.

19. A non-transitory computer-readable storage medium comprising computer-executable instructions that, when executed by at least a processor of a server system, cause the server system to perform a method comprising:
accessing a base graph associated with a plurality of entities from a transaction database, the base graph comprising a plurality of nodes connected via a plurality of edges, the plurality of nodes comprising a plurality of labeled nodes and a plurality of unlabeled nodes, each node of the plurality of labeled nodes labeled with one of a fraudulent label and a non-fraudulent label; and
assigning via a Graph Neural Network (GNN) model, one of the fraudulent label and the non-fraudulent label to each unlabeled node of the plurality of unlabeled nodes based, at least in part, on the base graph, wherein the assigning comprises performing a first set of operations comprising:
generating a plurality of sub-graphs based, at least in part, on splitting the base graph, each sub-graph of the plurality of sub-graphs comprising a subset of nodes from the plurality of nodes, each subset of nodes corresponding to a particular label,
generating via a Siamese Neural Network (SNN) model, a plurality of filtered sub-graphs based, at least in part, on the plurality of sub-graphs and a set of pre-defined threshold values,
generating via the GNN model, a plurality of sets of embeddings based, at least in part, on the plurality of filtered sub-graphs, each set of embeddings of the plurality of sets of embeddings generated corresponding to each filtered sub-graph of the plurality of filtered sub-graphs,
generating an aggregated node embedding for each node of the plurality of nodes based, at least in part, on aggregating the plurality of sets of embeddings using an aggregation function,
generating via a dense layer of the GNN model, a final node representation for each node of the plurality of nodes based, at least in part, on the aggregated node embedding for each node of the plurality of nodes, and
assigning one of the fraudulent label and the non-fraudulent label to each unlabeled node of the plurality of unlabeled nodes based, at least in part, on the final node representation for the corresponding unlabeled node.

20. The non-transitory computer-readable storage medium as claimed in claim 19, wherein the method further comprises:
accessing historical payment transaction data from the transaction database associated with the server system, the historical payment transaction data comprising labeled and unlabeled electronic transaction data associated with the plurality of entities;
extracting a plurality of graph features based, at least in part, on the historical payment transaction data; and
generating the base graph based, at least in part, on the plurality of graph features, the base graph being a homogeneous graph.
